(19) United States
(12) Patent Application Publication
(10) Pub. No.: US 2019/0050887 A1
(43) Pub. Date: Feb. 14, 2019

(54) DETERMINING EQUITY REWARDS BASED UPON PURCHASE BEHAVIOR

(71) Applicant: Bumped, Inc., Portland, OR (US)

(72) Inventor: David Nelsen, Lake Oswego, OR (US)

(21) Appl. No.: 16/101,304

(22) Filed: Aug. 10, 2018

Related U.S. Application Data
(60) Provisional application No. 62/543,884, filed on Aug. 10, 2017.

(51) Int. Cl. G06Q 30/02

(52) U.S. Cl. CPC G06Q 30/0226; G06Q 30/0201

(57) ABSTRACT

Embodiments are disclosed which relate to a system and methods for receiving user loyalty selections for a business and providing equity rewards to a user when the user executes a purchase at the business to which the user has selected loyalty. One disclosed embodiment provides a system having a memory storing instructions executable by the processor to receiving a loyalty selection from a user, the loyalty selection comprising a selection of a business listed in a rewarding-business index of a loyalty platform to receive an equity reward associated with the business; matching a user purchase with the business by correlating purchase details with the rewarding-business index; determining an amount of the equity reward based on a monetary value of the user purchase, a user transaction history, and business reward policies; and displaying the amount of the equity reward to the user.

### CROSS REFERENCE TO RELATED APPLICATIONS

The present application claims priority to U.S. Provisional Patent Application No. 62/543,884, entitled “DETERMINING EQUITY REWARDS BASED UPON PURCHASE BEHAVIOR,” and filed on Aug. 10, 2017. The entire contents of the above-referenced application are hereby incorporated by reference for all purposes.

### FIELD

The present application relates to methods and systems for providing equity rewards to a user based upon the user's purchase behavior.

### BACKGROUND AND SUMMARY

Many different reward programs have been implemented over time in order to incentivize user loyalty to a particular brand or business. Simple programs such as a “buy 10, get one free” punch card at a local coffee shop or delicatessen are time-tested methods used to promote and reward user loyalty. Cash rewards, as well, have been used in the form of mail-in rebates, providing monetary incentives for users considering the purchase of larger, more expensive items such as appliances or motor vehicles. More recently, gift certificates and cash rewards are known conventional reward programs offered to promote loyalty to a particular credit card. Furthermore, mileage programs have long been a reward program offered to instill loyalty to particular airlines, or alternatively, a credit card promoted by an airline

Conventional reward programs, such as those described above, suffer because they fail to build user loyalty with a particular company in the long term. One reason for this failure is that one-time rewards, like a rebate, or a physical prize awarded after redeeming a certain number of accumulated points, do little to align the interests of the user with the interests of the rewarding company beyond a certain limited time frame. Another factor limiting the success of conventional reward programs to generate user loyalty is the effort required on the part of the user to record and/or submit proof of purchases which may be eligible for a reward, such as when a user is required to enter a code or other proof of purchase into an online account in order to receive credit/points for the purchase, or when a proof of purchase must be mailed-in in order to receive a rebate. Additionally, in points based rewards programs, points accrued often come with an expiration date or date when the points must be redeemed by, thereby placing an additional burden on the user to hurriedly redeem their points, further exacerbating the inability of such programs to maintain user loyalty over the long term. Points frequently have no real value outside the scope of a rewards program, and as such, mean little to customers in the grand scheme of their financial picture. Furthermore, rewards programs often have unrealistic goals requiring many dollars spent and points earned in order to earn a small reward.

The inventors herein have developed systems and methods to at least partially address the above issues associated with reward programs. In one example, a method comprising: receiving a loyalty selection from a user, the loyalty selection comprising a selection of a business listed in a rewarding-business index of a loyalty platform to receive an equity reward associated with the business; matching a user purchase with the business by correlating purchase details with the rewarding-business index; determining an amount of the equity reward based on a monetary value of the user purchase, a user transaction history, and business reward policies; and displaying the amount of the equity reward to the user. In this way, by providing equity rewards associated with a business to which the user has chosen loyalty, based on purchases made by the user at the business, wherein the equity rewards associated with the business may increase in value over time based on performance of the business, user loyalty to the business may be generated to a greater extent, and maintained over longer durations, than in conventional reward programs. Further, the systems and methods herein disclosed may enable reduced effort on the part of the user to participate in, and benefit from, loyalty reward programs offered by preferred brands/businesses. In one example, by automatically monitoring financial transactions of the user conducted with payment media linked to an account of the user on the loyalty platform, details of the financial transaction being compared to a rewarding-business index (a list of all business actively participating in the equity loyalty platform including information associated with each business), the user may receive equity rewards for financial transactions without the need for the user to determine if each financial transaction is eligible for a reward, mail in a receipt or otherwise prove the purchase, or create a new account for each rewarding company.

The above summary is provided to introduce a selection of concepts in a simplified form that are further described below in the Detailed Description. This summary is not intended to identify key features or essential features of the subject matter, nor is it intended to be used to limit the scope of the subject matter. Furthermore, the subject matter is not limited to implementations that solve any or all of the disadvantages noted above or in any part of this disclosure.

### BRIEF DESCRIPTION OF THE DRAWINGS

FIG. 1A shows an example of a loyalty platform.

FIG. 1B shows an example of a computing system implementing the loyalty platform.

FIGS. 2A, 2B, and 2C show a flowchart representing an example transaction process.

FIG. 3 shows example rewards over time for a single user.

FIG. 4 shows an example distribution of business across markets.

FIGS. 5-10 show example graphical user interfaces of the loyalty platform.

FIG. 11 shows an exemplary communication diagram of the loyalty platform

FIGS. 12 and 13 show examples of equity forfeiture as equity appreciates and depreciates.

FIG. 14 shows an example communication diagram illustrating example information sent and/or received among computing devices associated with the loyalty platform.

FIGS. 15-32 show an example user registration process of a loyalty platform.

FIGS. 33-34 show example graphical user interfaces of the loyalty platform.

FIGS. 35-39 show an example equity sell process of a loyalty platform.

FIG. 40 shows an example graphical user interface for requesting a bank transfer of electronic funds.

### DETAILED DESCRIPTION

The following description relates to systems and methods for a user loyalty and rewards platform providing rewards of equity to users based on purchasing habits

The proposed system herein is a new kind of shopping experience where traditional factors that drive purchasing decisions such as price, quality, and trust, further include equity or stock participation in a business which may be given to a user who has selected an exclusionary loyalty policy with the business and thus receives rewards from the selected business for purchases made in a market, and may not receive rewards from competing businesses in the same market. By the same token, the business may also be able to develop a more detailed understanding about the relationship that the business has with its users

The embodiments disclosed herein may greatly benefit companies in generating user loyalty. The system described herein provides a platform where users select loyalties in a given market, and based upon the user's selected loyalty to a brand or merchant within a given market, the platform allocates to the customer a reward which may comprise equity of the selected brand when the user executes purchases or transactions with that brand. As an example, a user may register a payment medium (in one example, a credit card) with the platform of the present application and when a purchase is made using that payment medium, the platform receives information pertaining to that purchase (via tracking of the payment medium), associates the purchase with a user account on the loyalty platform, and compares a description of the transacting business included in the purchase information with a digital record of businesses registered with the platform (the rewarding-business index), to match the transacting business with a business registered with the loyalty platform. If the transacting business matches with a business registered with the loyalty platform, and that business is actively providing rewards to loyalty customers through the loyalty platform, the platform then looks up a user's loyalty selections to check if the user has selected loyalty to the transacting business. The user may select loyalty to only one business within a market. If the user has selected loyalty to the transacting business within a market, the platform charges the business a cumulative percentage of the transaction amount comprising at least an equity percentage and a service percentage, and then purchases equity of the transacting business of an amount equal to the value of the equity percentage and distributes this to an account of the user on the loyalty platform.

In one example, the loyalty platform described herein may include a loyalty platform configured to communicate with user computing devices (in some examples, smart phones, laptops, desktop computers via which users may enter information that is sent to the loyalty platform), business devices (in one example, point of sales devices), an equity clearing system, and a payments system. The loyalty platform may establish loyalty policies with various businesses across multiple markets. The loyalty policies may include an indication of the types of rewards offered for user purchases. The loyalty platform may store user accounts that include user loyalty selections, payment medium information, and other information associated with each user. The loyalty platform may track user purchases made at various businesses stored in a rewarding-business index (in one example, by tracking credit or debit card purchases and/or by receiving purchase details from business point of sale devices), and via the user account information, determine if user purchases have occurred with a business to which the user has made a loyalty selection. If a user purchase has been made at a business to which the user has selected loyalty, the platform may determine, via the loyalty policy for that business (herein also referred to as business loyalty policies), a reward for the user for the purchase. In some examples, the reward may include stock or other equity in the business. If the reward is an equity reward, the platform may communicate with an equity clearing system to purchase stock in the business and then assign the amount of stock (which may be a fractional share) to the user. Via the payments system, the platform may collect a payment equal to or greater in value than the reward from the business, and the payment may be used to purchase the equity reward for the user.

In one example, the loyalty platform negotiates a reward discount with a given business, such as a coffee company, for all sales stemming from the loyalty platform. For example, the reward discount may be 1% of the transaction amount. The loyalty platform may charge the business a surcharge of the reward discount, such as 0.25%. Via the loyalty platform in communication with a user computing device, the platform may offer the reward discount to the user. If the user makes a purchase at the business, the loyalty platform may be informed of the transaction through a payments system that tracks transactions (in some examples, via debit or credit card, virtual wallets, etc.), directly from the business, or from the user conducting the transaction via the loyalty platform. The loyalty platform may then charge the business 1.25% of the transaction amount, via the payments system. The loyalty platform then purchases equity in the coffee company via the equity clearing system at a value of 1% of the transaction amount and assigns a fractional share to an account of the user on the loyalty platform (keeping the 0.25% of the charge for the loyalty platform).

In one example, to encourage business loyalty, a user may only be allowed to make a loyalty selection to one business or brand in given market (wherein, in one example, a market is a grouping of businesses or brands as defined by the loyalty platform providing similar products/services, and as such, businesses in a market as defined herein may compete for user loyalty). Then, if the user makes a transaction with another business or brand in the same market, the user is not offered a reward for that transaction and/or may be penalized by being given reduced rewards in the future for the business to which the user has made a loyalty selection. In one example, the user may be prompted to make a loyalty selection to a business, based on a position of the user being within a threshold distance of the business, wherein the threshold distance may be a pre-determined threshold, such as 1 mile, or wherein the threshold may be based on an estimated travel time of the user to the business, such as 5 minutes. In some examples, the user may be presented offers to switch loyalties from one business to another, herein referred to as loyalty-switch offers. Further, rewards offered to the user may change over time to encourage loyalty selection and/or encourage long-term loyalty to a business

In an example illustrating one way loyalty selections and markets may function, a user may make a loyalty selection to a first business or brand included in a first market of the loyalty platform and not included in a second market of the loyalty platform, where the loyalty selection to the first business excludes the user from receiving equity rewards from a second business included in the first market of the loyalty platform, and wherein the loyalty selection does not exclude the user from receiving equity rewards from a third business, wherein the third business is included in the second market of the loyalty platform and not included in the first market of the loyalty platform. As the previous example illustrates, loyalty selections may be exclusionary, and may, in some cases, preclude the user from receiving equity rewards via the loyalty platform from businesses/brands competing with a business/brand to which the user has an active loyalty selection, however, this may not preclude the user from making an additional loyalty selection to a non-competing business (that is, a business/brand that is not included in the same market as defined by the loyalty platform). In another example, in cases where a single brand/business is listed in multiple markets of the loyalty platform, loyalty selections may be made to that business/brand in each of the markets in which it is listed, or alternatively, the user may make a loyalty selection to the business/brand in a first market in which the business/brand is included, but may make a loyalty selection to a competing business/brand in a second market in which the business/brand is listed. As a more specific example, a business such a Walmart may be listed in multiple markets of the loyalty platform, such as in both a “Groceries” market, as well as in an “Apparel” market, and as such a user may make a first loyalty selection to Walmart in the “Groceries” market and a second loyalty selection to Walmart in the “Apparel” market, or alternatively, the user may make a loyalty selection to Walmart in one of the two markets but not the second, or in neither of the two markets

Businesses such as apparel retail companies may reward a user for a transaction, wherein an item was purchased, only to have the user return the item for a refund at a later date. In one example, to avoid the business granting rewards for transactions that are ultimately voided, the platform may be configured to be notified of the return and the platform may then sell or otherwise remove the reward from the user's account (reverse journal the stock transaction rewarded). In such examples, the user may still be entitled to any gains in value made to the reward since the original transaction. Conversely, the user may then be subject to losses if the reward were to lose value since the original transaction.

The fractional shares assigned to the account of the user, loyalty selections made by the user, special offers, loyalty switches, and any other account information may be presented to the user to allow the user to control loyalty selections, loyalty switches, and other actions. The user may be allowed to sell his or her fractional shares, or transfer earned rewards from one business to another if loyalty policies allow. Such an arrangement may encourage long term participation in the loyalty platform by giving the user flexibility in the loyalty process should the user move, change purchasing needs (in one example, after having a child, a user may choose to shop at different businesses than before having a child), or otherwise desire to switch business loyalty.

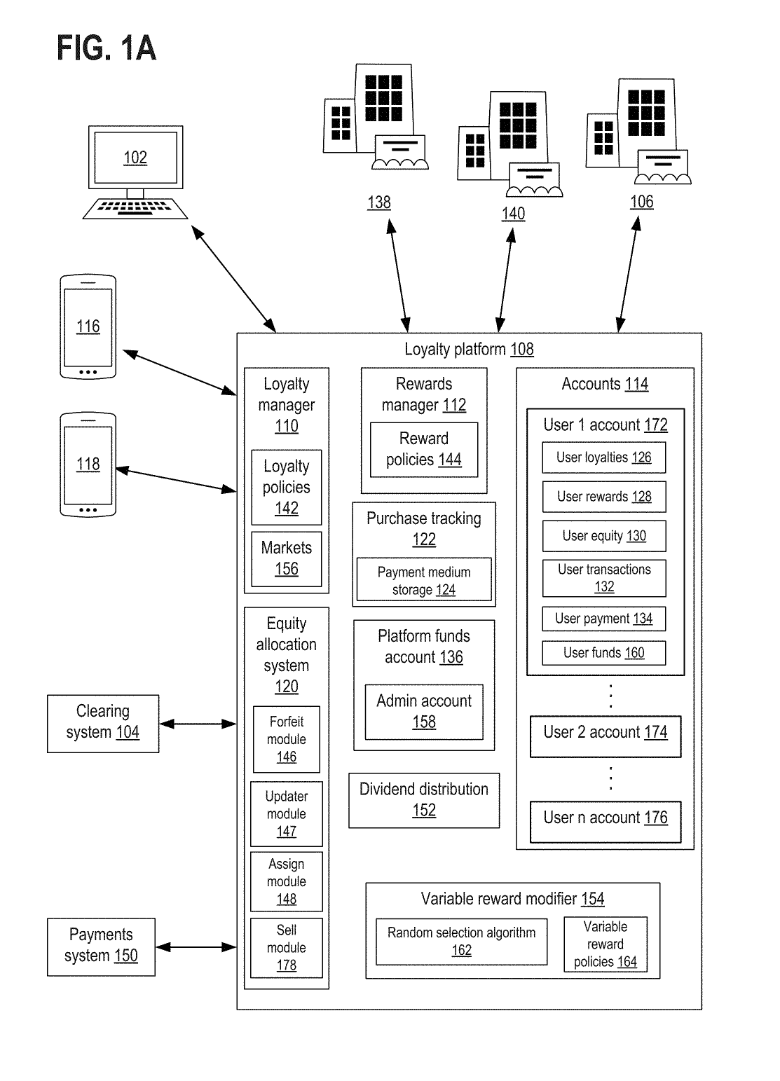

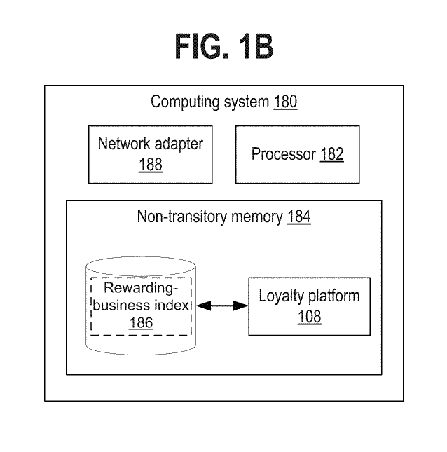

FIG. 1A schematically shows an example loyalty platform 108. Loyalty platform 108 may be implemented by one or more computing systems. In one example, loyalty platform 108 may be implemented by a server. In another example, loyalty platform 108 may be implemented by a plurality of computing systems working in concert, such as through a network connection, wherein each of the plurality of computing systems may implement part of the loyalty platform 108. Loyalty platform 108 may be configured to electronically communicate with external computing systems, such as user computing systems 102, 116, and 118, businesses 106, 138, and 140, clearing system 104, and payments system 150.

User computing devices 102, 116, 118, which may interface with loyalty platform 108 via a network connection, may each be associated with at least one user, and further associated with at least one user account stored in non-transitory memory of one or more a computing systems implementing loyalty platform 108. As an example, use of the term “user” or “prospective user” or may refer to any legal entity, whether individual or corporate. Each user computing device may be associated with a user, and thus enable the user to communicate with loyalty platform 108. In one example, user computing devices 102, 116, 118, may be associated with user accounts 172, 174, 176 and may be any associated corporation or associated individual. Users associated with user computing devices 102, 116, and 118 may register with loyalty platform 108 and make user purchases at a plurality of businesses 138, 140, 106. Based upon user loyalty selections (selecting one business of the plurality of businesses 138, 140, 106 in a given market) the user may be entitled to a reward upon executing a user purchase with the selected business. In one example, upon allocation of the reward to a user account on the loyalty platform, the loyalty platform may transmit data via network connection to the user computing device to display the amount of the equity reward to the user by rendering the amount of the equity reward in a user interface of a user computing device

User computing devices 102, 116, 118, may each include a processor, memory, communication interface, display, user input devices, GPS/position sensors and/or other components. In one example, a location of user computing device 116 may be ascertained via a GPS system associated therewith. In one example, information from loyalty platform 108 may be transmitted to user computing device 118 via a network connection (such as the Internet) between user computing device 118 and loyalty platform 108, for rendering within an interface or display implemented at user computing device 116. The display may be used to present a visual representation of the loyalty platform 108. This visual representation may take the form of a graphical user interface (GUI). The communication interface may be configured to communicatively couple the loyalty platform 108 with one or more other computing devices, such as the payments system 150, clearing system 104, user computing devices, and/or business computing devices. The communication interface may include wired and/or wireless communication devices compatible with one or more different communication protocols. As non-limiting examples, the communication interface may be configured for communication via a wireless telephone network, or a wired or wireless local- or wide-area network. User input device(s) may comprise one or more user-input devices such as a keyboard, mouse, touch screen, or game controller.

Clearing system 104 may comprise one or more computing devices each including a processor, memory, communication interface, and/or other components. The memory of the computing device(s) of clearing system 104 includes instructions or rules for managing a clearing house for assignment of public shares. As a further example, clearing system 104 may comprise a clearing house for assignment of non-public shares. Clearing system 104 may communicate with equity allocation system 120 of loyalty platform 108 in order to execute transactions such as the buying or selling of shares via the assign module 148 of the equity allocation system 120

Payments system 150 may comprise one or more computing devices each including a processor, memory, communication interface, and/or other components. The memory of the computing device(s) of payments system 150 includes including instructions or rules for disbursing and/or receiving payments via one or more banks, bank accounts, credit card accounts, checking accounts, online payments systems, or virtual wallets. In some examples, payments system 150 may include discrete accounts, each of which may be associated with a user account 172, 174, 176 of accounts 114 on the loyalty platform 108.

Businesses 138, 140, 106 may be any merchant, business place, brand, or entrepreneur or entrepreneurial entity associated with loyalty platform 108. As an example, use of the term “business” or “merchant” or “brand” may contemplate any stock corporation, whether private or public. Each business may communicate with loyalty platform 108, for example, via a business computing device. Each user computing device may include a processor, memory storing instructions executable by the processor, display, user input devices, and a communication interface.

Any of the computing devices, modules, or elements described herein with reference to FIG. 1A and FIG. 1B may communicate with each other via a network. For example, loyalty platform 108 may communicate with clearing system 104 and payments system 150 via a network

Loyalty platform 108 may include a plurality of modules including a loyalty manager 110, rewards manager 112, accounts 114, equity allocation system 120, purchase tracking 122, platform account 136, dividend distribution 152, and variable reward modifier 154. As illustrated in exemplary FIG. 1A, the various modules of the loyalty platform 108 may include instructions stored in non-transitory memory 184 that are executable by processor 182 of computing system 180. In other examples, the modules may be stored on multiple memories and/or executed by multiple processors distributed across multiple computing devices.

Loyalty manager 110 administers loyalty policies 142 and updates user loyalties 126 of accounts 114 with updated loyalty policies relating to businesses to which a user may select loyalty. Loyalty manager 110 includes loyalty policies 142 and markets 156. Markets 156 may be a database or module which may further represent suitable information regarding categorization of businesses affiliated with loyalty platform 108 into discrete markets or business segments wherein the businesses segmented into different markets compete in some way or offer similar products and/or services. Loyalty manager 110 may represent suitable information regarding loyalty selections of the loyalty platform 108. As a non-limiting example, loyalty manager 110 may include market definitions for a market such as “Groceries (National).” In some examples, businesses not affiliated and/or businesses pending affiliation or partnership with the platform may be listed in the markets database. In an example, businesses listed in the markets database may have different statuses such as “non-partner” (if not partnered with the platform), “partner” (if partnered with the platform), and “pending partner” (if partnership with the platform is pending). Business statuses in the markets 156 may be useful as they may allow users to be made aware of businesses which may or may not become platform partners over time, which may factor into a user's decision to select loyalty to a particular business in a market. In one example, a “Groceries (National)” market might include large, nation-wide grocery chains, not limited to, for example, COSTCO, ALBERTSON'S, DOLLAR GENERAL, KROGER. In an example, a market may have any number of businesses included in the market, and there may be any number of markets included in markets 156. In an example, market definitions may be defined by administrators of the platform account 136.

Additionally, loyalty manager 110 may include loyalty policies 142 which may further include instructions or information relating to managing loyalties across markets 156 of loyalty platform 108. Separating businesses into individual markets is not so simple, as many business and/or merchants exist not only in one market, but are diversified and compete in many different markets. For example, a massive big-box store, such as WALMART sells not only groceries, but also home goods such as electronics, prescription medications, and clothing. As such, loyalty manager 110 may further include loyalty policies 142 that limit the loyalty selections for a user across different markets, so that a user may only select loyalty to a particular business across different markets (of markets 156) a particular number of times. In an example, a user may be allowed to select loyalty to only one business for a single market. In another example, a user may be allowed to select a first loyalty to a business in a first market and to select a second loyalty to the business in a second market. In a further example, a user may be allowed to select loyalty to a business as many times as allowed by loyalty policies 142 across different markets, if the business is “multi-listed” or offered as a loyalty selection across different markets. In a further example, a user may be allowed to select loyalty to one or more businesses listed within a market.

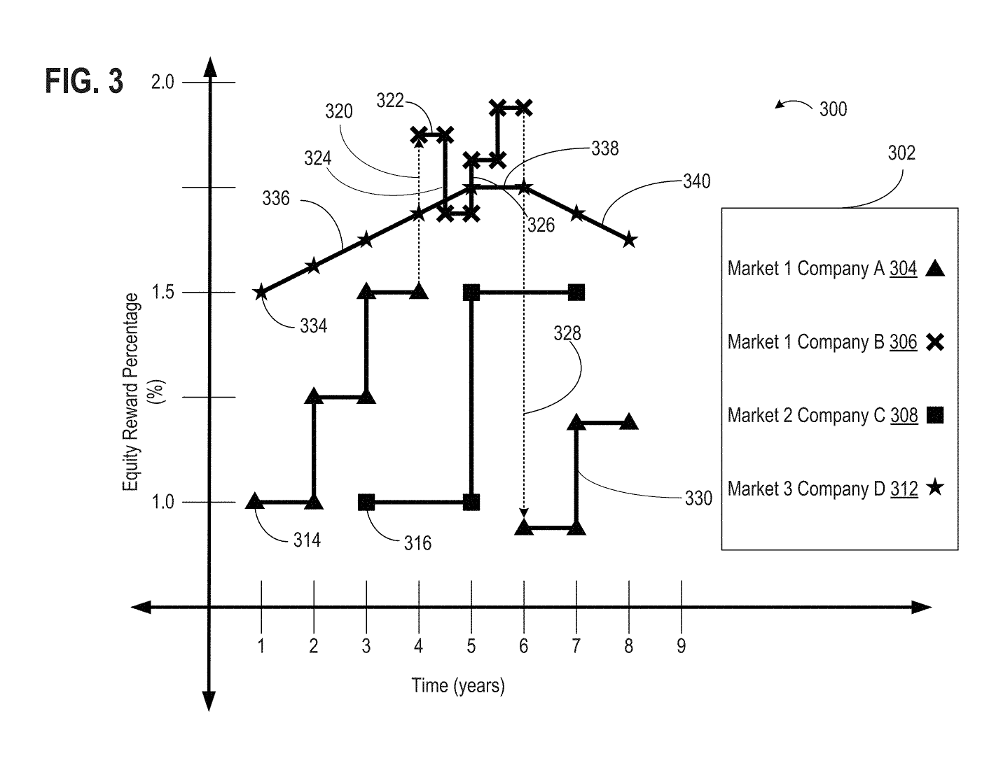

Rewards manager 112 may be a module or database and may include reward policies 144 which may further include instructions or information comprising rules for providing equity rewards based upon a user's selected loyalty to a transacting business (business with which transaction occurs). Additionally, reward policies 144, in an example, may include specific rule sets regarding equity rewards for a user executing purchases at or with a particular business (herein referred to as business reward policies) to which the user has selected loyalty via the loyalty platform. As an example, and further illustrated in FIG. 3, a user's long-term loyalty may be rewarded with increased equity rewards. In some examples, shown further in FIG. 3, equity rewards may increase over time. In some examples, equity rewards may randomly and/or predictably vary over time. In some examples, variable, increasing, and/or long-term loyalty rewards may form stronger user-business relationships and user loyalty. Additionally, if a user switches loyalties from a first company in a first market to a second company in the first market, a promotional, “loyalty-switch offer” may be made available to the user. In an example, a “loyalty-switch offer” may comprise a period of increased equity rewards per transaction with the business. In an example, a “loyalty-switch offer” might also comprise any of a cash reward, discounted purchases, a set amount of equity, or any other loyalty-switch promotion desired by the administrators of the loyalty platform. As a further example, administrator account 158 or platform account 136 may modify reward policies 144 of rewards manager 112.

Accounts 114 may be a module or database including instructions, information, and/or rules relating to personal and loyalty platform information for each user 102, 116, 118 associated with the loyalty platform 108. As an example, users 102, 116, and 118 may register with loyalty platform 108 via a smartphone, computer, point-of-sale unit at businesses 106, 138, 140, or other network-enabled computing device in order to build and create user accounts 172, 174, 176 associated with (as an example) users 102, 116, and 118, respectively, the accounts being stored in accounts 114. As an example, accounts 114 may include user information for each user, including user loyalties 126, user rewards 128, equity assigned to user 130, user transactions 132, user payments 134 (including, in some examples, payment preferences, methods, or payment media), and user funds 160 each associated with a respective user, such as user 102. As an example, user loyalties 126 may include the businesses and/or brands which the user has selected via a loyalty selection for a single business in a defined market. User rewards 128 of a user's account may include the rewards for which the user is currently eligible for when making a transaction using payment media registered with purchase tracking 122 and when the transaction is between the user and a business or merchant who the user has selected via a loyalty selection. User equity 130 may include equity currently assigned to a user. User transactions 132 may include a history of transactions executed by a user tracked by loyalty platform 108 via purchase tracking 122. User payment 134 may include user preferences for payment or a virtual wallet held by the loyalty platform 108. User funds 160 may include electronic funds stored for a user which may be used for purchases made via the platform or, as an example, user funds 160 may include funds received via dividend payments from dividend distribution 152. As an example, accounts 114 may be updated continuously, via communication between rewards manager 112, loyalty manager 110, purchase tracking 122, equity allocation system 120, dividend distribution 152 and variable reward modifier 154, on a schedule, or in response to a trigger in order to keep user account information updated so that a user may be able to receive up-to-date information regarding their account. In an example, purchase tracking 122 may trigger a user account 172 update based upon receiving a notification of a tracked transaction between a user and a business, and purchase tracking may command rewards manager 112 and loyalty manager 110 to update the user account 172

Equity allocation system 120 may manage assigning, selling, and forfeiting equity as well as updating current share prices. Equity allocation system 120 may additionally include forfeit module 146, updater module 147, assign module 148, and sell module 178 may be a module or database configured with rules and/or instructions in order to execute buy, sell, and/or forfeit orders of fractional or whole equity between loyalty platform 108 and clearing system 104 as well as, in some examples, between accounts 114 (including user accounts 172, 174, 176) and platform account 136

Purchase tracking 122 may be a database or module configured to include instructions and rules configured to track virtual and real-world (e.g., in-store) purchases between users 102, 116, 118 and businesses 138, 140, 106. The purchase tracking system may further include payment medium storage database 124 in order to track purchases for user accounts 172, 174, 176 associated with users 102, 116, 118 who may execute transactions using payment media which have been registered and stored at payment medium storage 124. As an example, payment media stored within payment media storage 124 may include any applicable payment methods not limited to credit cards, debit cards, and online payment systems (for example, PAYPAL). In an example, payment medium storage 124 may include registration information relating to credit cards used for transactions between users and businesses. In another example, payment medium storage 124 may include registration information relating to only payments systems used for transaction between users and businesses. In another example, purchase tracking 122 may receive a notification or indication that a user has executed a transaction (for example, purchase or return).

The loyalty platform 108 may additionally include platform account 136 which may comprise an equity account tied to the loyalty platform 108, and as an example, in some cases the loyalty platform 108 may accumulate shares and/or funds based upon a user's transaction with a merchant where the transaction is tracked through the platform. In some instances, when a user forfeits shares the loyalty platform 108 may retain the forfeited shares at platform account 136. Furthermore, platform account 136 may additionally comprise an administrator account 158 which may provide platform administrators with rights to make any modifications to the loyalty platform—for example, adding or removing businesses to the loyalty selections available through loyalty manager 110, modifying rewards options available through rewards manager 112, modifying accounts 114, modifying equity allocation 120, modifying dividend distribution 152, and varying the rewards provided to users at variable reward modifier 154

Loyalty platform 108 may also include dividend distribution 152 as a database or module comprising instructions or rules which may enable communication with clearing system 104 in order to distribute dividend payments whenever they are set to occur (such as quarterly). Clearing system 104 may, as an example, have information relating to when dividend payments are to be made and how much money per share may paid-out. Dividend payments handled by dividend distribution 152 may, in some examples, be sent to user funds 160 in user account 172. In another example, dividend payments handled by dividend distribution 152 may be sent directly to payments 150 via instructions included at user funds 160 to send payment to an account with payments 150 associated with user account 172

Variable reward modifier 154 may be a module or database containing instructions configured to provide a reward modification to the normal reward, based upon random selection. As an example, the user may be entitled to a reward, or a normal reward, based upon the user's loyalty selection to a business, and, the normal reward may be modified based upon variable reward policies (discussed herein) to form a modified reward. As explained herein, when a user 102, 116, 118 executes a transaction, the purchase tracking 122 notifies variable reward modifier 154 of the transaction (which may have been made between a user and business wherein the user had made a loyalty selection to the business of the transaction) and further queries variable reward modifier 154 to see if the normal reward may receive a modified reward

Turning now to FIG. 1B, example computing system 180 is shown. Computing system 180 may implement loyalty platform 108 alone, or in combination with other computing systems. In one example, computing system 180 is a server. Computing system 180 includes processor 182, network adapter 188, and non-transitory memory 184. Processor 182 may include one or more physical devices configured to execute instructions. For example, processor 182 may be configured to execute instructions that are part of one or more applications, services, programs, routines, libraries, objects, components, data structures, or other logical constructs included in loyalty platform 108. Network adapter 188 may comprises one or more physical device associated with computing system 180, enabling transmission and reception of data by computing system 180. In one example, network adapter 188 enables computing system 180 to connect to a computer network, such as the Internet, and exchange data therewith, such as data which may enable tracking of user purchases and matching between transacting businesses and businesses registered with the loyalty platform (and therefor in included in the rewarding-business index). Non-transitory 184 memory includes one or more physical devices configured to hold data, including instructions executable by the processor to implement the methods and processes described herein. When such methods and processes are implemented, the state of non-transitory memory 184 may be transformed—e.g., to hold different data. The terms “module” and “program” may be used to describe an aspect of the computing system implemented to perform a particular function. The terms “module” and “program” may encompass individual or groups of executable files, data files, libraries, drivers, scripts, database records, etc. Non-transitory memory 184 includes the various files/routines/methods of loyalty platform 108 that when executed by processor 182 perform one or more of the steps herein described with reference to one or more of the disclosed methods. Computing system 180 may optionally include display(s), user input device(s), communication interface(s), and/or other components.

As shown in FIG. 1B, non-transitory memory 184 includes rewarding-business index 186. Rewarding-business index 186 may be stored within non-transitory memory 184 of computing system 180, and may comprises a database or module with a list of businesses registered with loyalty platform 108 stored therein. The list of businesses registered with loyalty platform 108 may further include information pertaining to each of the businesses included within the list. In one example, rewarding-business index 186 may be used by computing system 180 in conjunction with purchase tracking 122 to quickly ascertain if a financial transaction executed at a business is eligible for an equity reward through the loyalty platform, by matching a description of the transacting business obtained by purchase tracking 122 with a description stored in rewarding-business index 186 associated with a business operating an active reward program (herein also referred to as a customer loyalty program) through loyalty platform 108. To facilitate accurate matching between a transacting business and its associated reward program/policies implemented by loyalty platform 108, rewarding-business index 186 may include various features, or pieces of data, relating to the businesses listed therein. In one example, rewarding-business index 186 comprises a database, with each entry therein corresponding to a unique business, said entry may comprise a name/description, a link to the reward/loyalty policies established by the business, the status of the reward program associated with that business (such as “active”, “cancelled”, “pending deposit of funds”, etc.) In one example, a business interested in offering equity rewards via loyalty platform 108 to customers, to incentivize greater customer loyalty, may register their business with loyalty platform 108. The registration process for businesses may include inputting information relating to the business into loyalty platform 108, this information may be stored in non-transitory memory of computing systems implementing loyalty platform 108. In one example, business information may be stored in rewarding-business index 186 of one or more computing systems implementing the loyalty platform 108, such as computing system 180. As an example, the business information input into the rewarding-business index as part of the business registration process may include a description of the business, business payment information, business contact information, business locations/addresses, business hours of operation, markets in which the business operates (which may also be stored in markets 156), business reward policies/loyalty policies defining how an amount of equity reward is calculated based on a monetary value of a user purchase and user transaction history (which may also be stored in one or more additional locations of loyalty platform 108, such as in loyalty policies 142, and reward policies 144), and other information which may enable the loyalty platform 108 to uniquely identify the business and operate a customer loyalty program customized for that individual business. In one example, a link to rules/policies for an equity reward program of a first business, implemented by loyalty platform 108 via computing system 180 may be included in an entry in rewarding-business index 186 associated with the first business. In one example, the rules/policies defining an equation or algorithm for calculating an amount of an equity reward to be allotted to a user with a loyalty selection to the business based on a user purchase made at the rewarding business using a payment medium (such as a credit card, debit card, virtual wallet, or other payment/payment media) previously linked with loyalty platform 108. Rewarding-business index 186 may be stored in a location of non-transitory memory 184 of computing system 180, and information stored therein may be accessed by computing system 180 upon execution by processor 182 of one or more methods stored in loyalty platform 108, some examples of which are described herein. In one example, rewarding-business index 186 may be accessed by purchase tracking 122 of loyalty platform 108 to attempt to match a description of a business with which a user recently made a purchase (herein also referred to as a transacting business description) using a linked payment medium, to a description stored in rewarding-business index 186. If the transacting business description matches a description of a business stored in rewarding-business index 186, the user may be entitled to a reward for the user purchase, and one or more additional actions may be taken, such as look-up of the reward policies linked with the rewarding business. The link may be stored in rewarding business-index 186 in a location associated with the rewarding business description, the link may point to a location of non-transitory memory 184 associated with reward policies 144. Thus, rewarding-business index 186 enables computing system 180 to automatically determine if a user purchase, tracked via purchase tracking 122, is eligible to receive a reward, or may be eligible to receive a reward based upon the user selecting a loyalty-switch offer, without requiring action on the part of the user. A business listed in rewarding-business index 186 may be removed, deleted, or overwritten, upon suspension or cancellation of the equity rewards program established for that business. In another example, upon cancellation or suspension of a customer loyalty program offered by a business, a flag may be set in the entry corresponding to that business in the rewarding-business index, thereby indicating that no equity rewards may be earned from user purchases at this business at this time, thus retaining business information within the rewarding-business index and bypassing the need to re-enter information relating to said business into the rewarding-business index in the event that the customer loyalty program associated with the business is resumed at a later time. In this way, rewarding-business index 186 enables rapid determination of which businesses provide equity rewards, which may influence user purchasing habits.

The following methods give examples of one or more methods which may be executed by a computing system, such as computing system 180, to implement a loyalty platform, such as loyalty platform 108, which may enable one or more improvements over conventional reward programs.

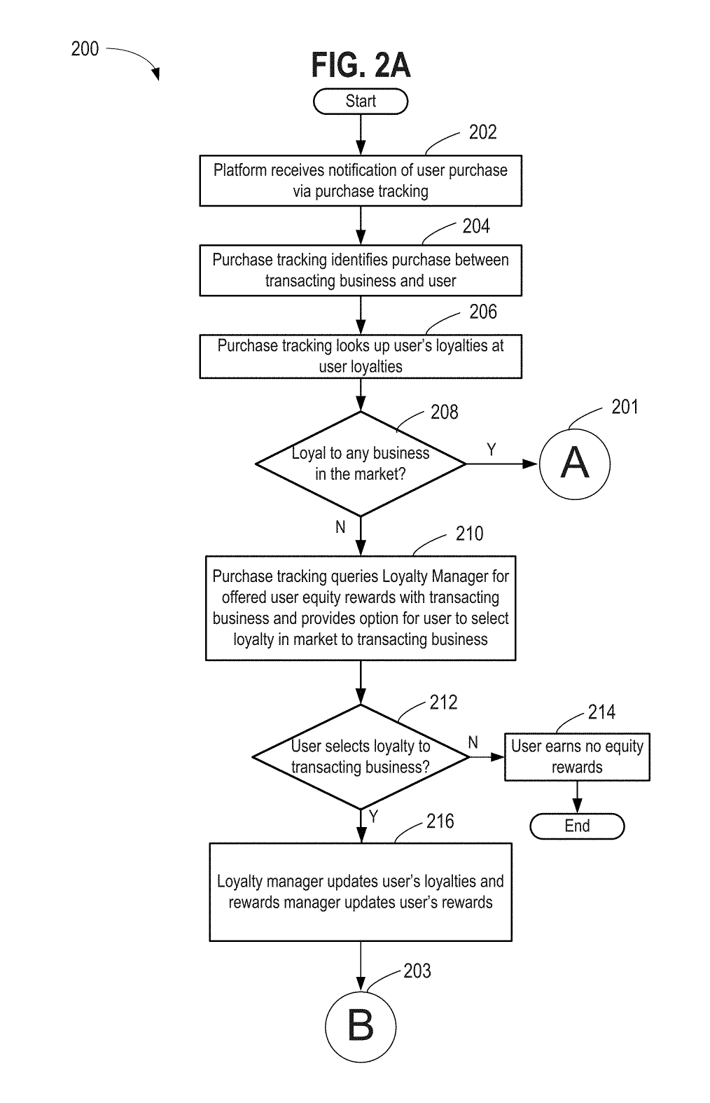

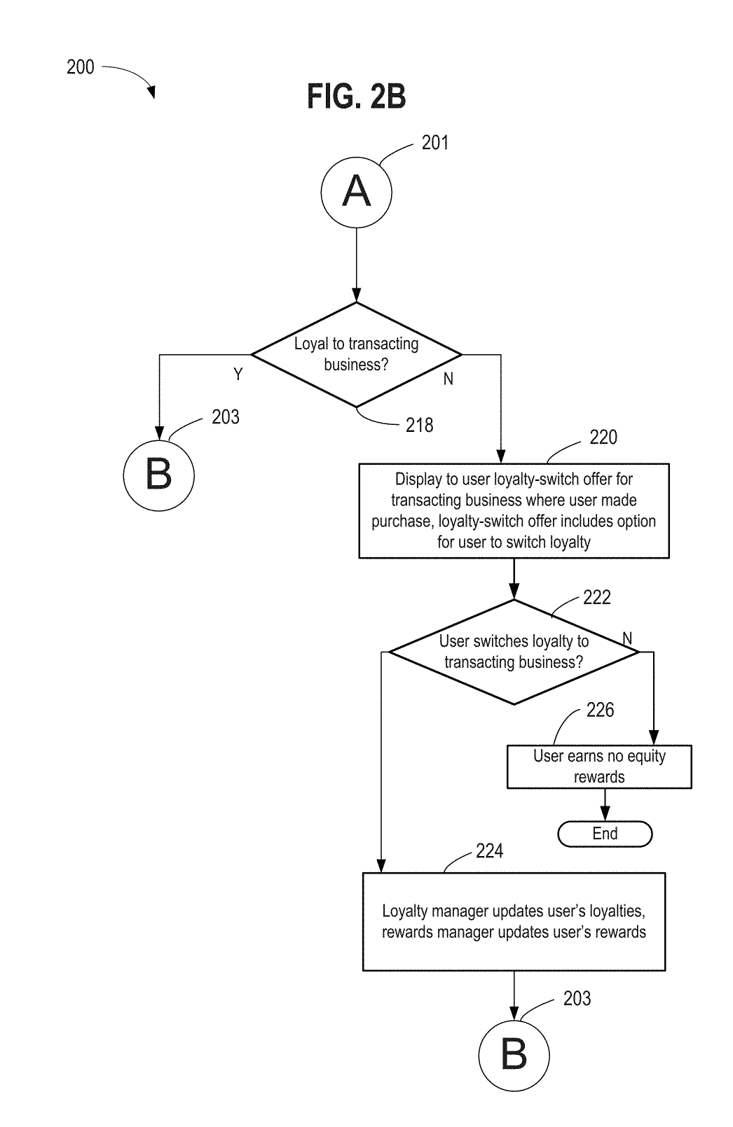

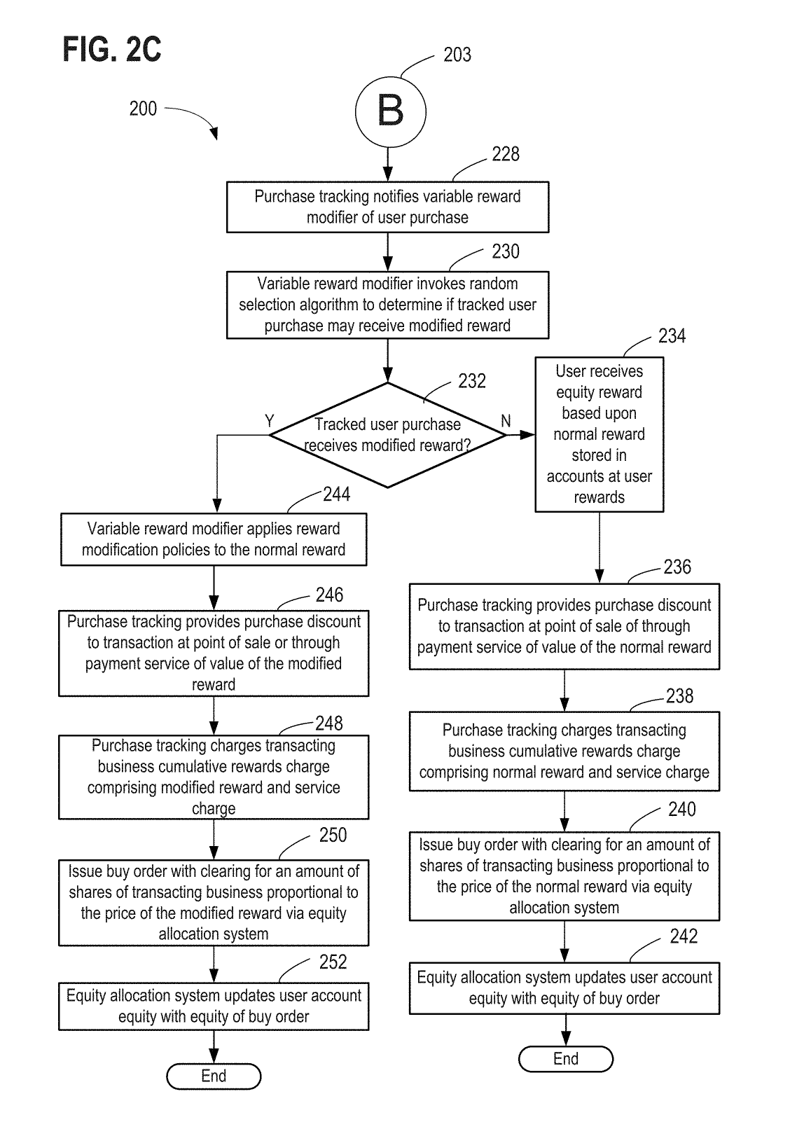

Turning now to FIGS. 2A, 2B, and 2C, a flowchart illustrating exemplary method 200 is shown. Method 200 is an example of a process illustrating how an online loyalty platform, such as loyalty platform 108, may track user purchases conducted with a payment medium registered/linked to a user account of the loyalty platform, and allocate equity rewards based on the monetary value of the user purchase, a user transaction history, user loyalty selections, business rewards policies/loyalty policies. In this and other examples, “loyalty” or “loyalty selection” may be a selection of a first business in a market made by a user entitling the user to certain privileges including, but not limited to, equity rewards, discounts, special offers, promotions, and others. Making a “loyalty” selection entitles the user to the receipt of privileges from the first business of the market to which the user has made their “loyalty selection” with, but may preclude, or exclude, the user from receiving privileges from a second business, or other businesses, in the market. In some examples, a user may be presented with a “loyalty-switch offer” which may be an offer for other privileges provided by a second business in the market, based upon a forfeit of loyalty and privileges to the first business and a selection of loyalty to the second business in the market.

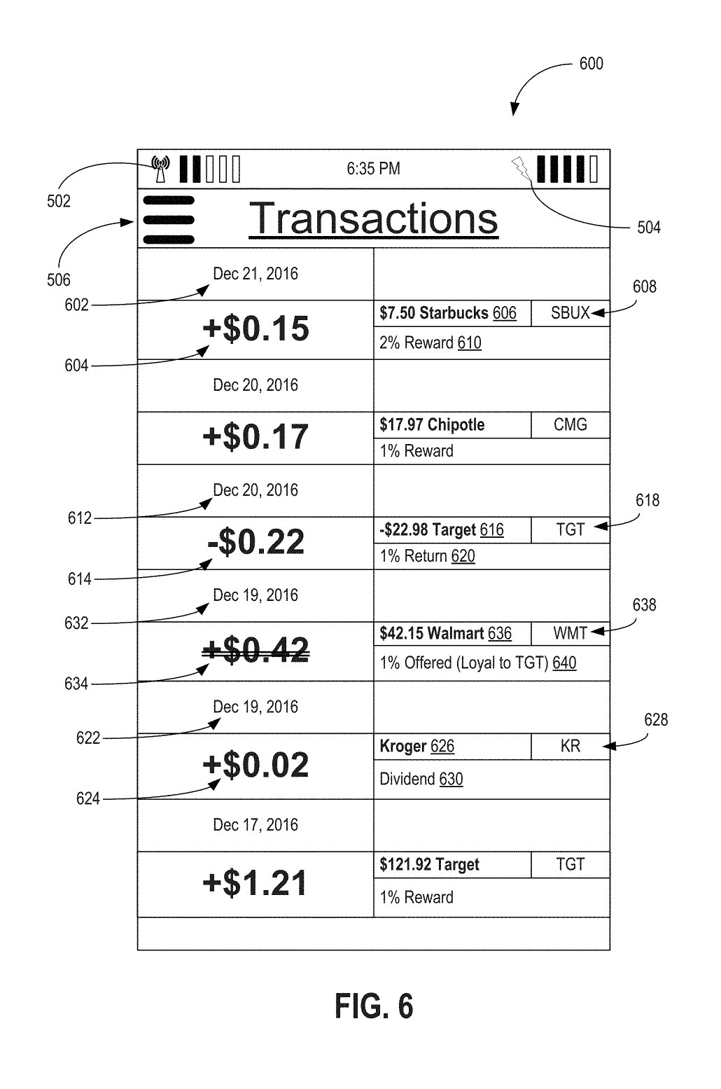

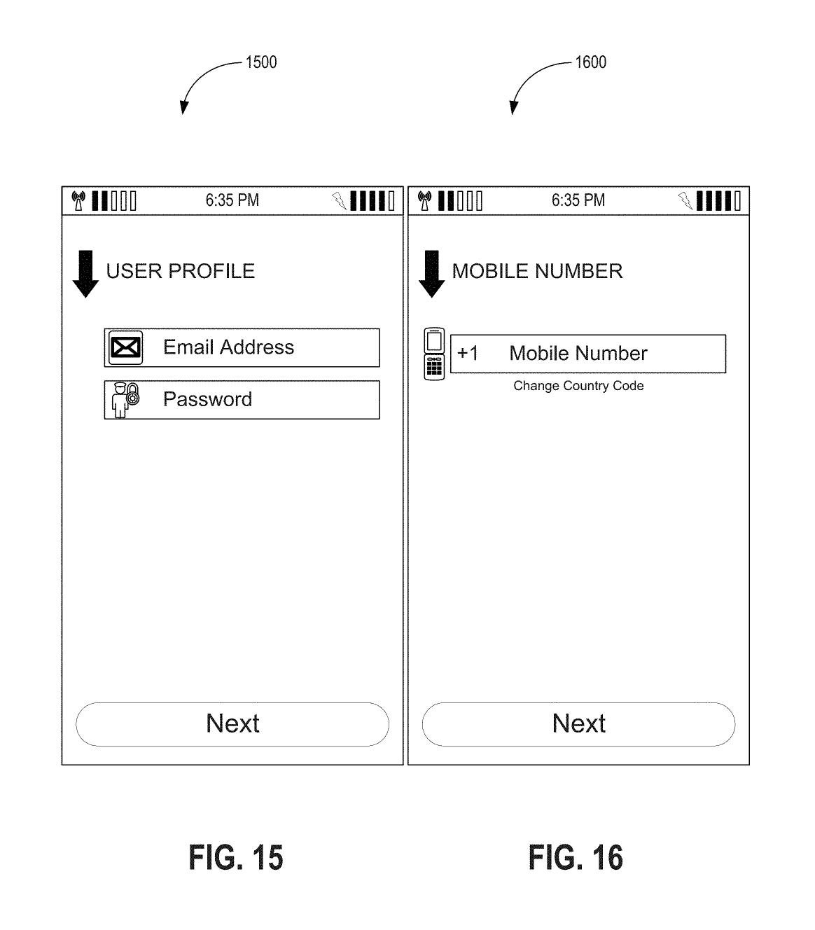

Beginning with 202, purchase tracking 122 of loyalty platform may receive an indication, or notification, that a user (for example, user 102, 116, 118 of FIG. 1A) has made a purchase or executed a transaction, comprising a monetary value of the transaction, with a transacting business. Purchase tracking 122 may further receive one or more purchase details, including information regarding the transacting business (herein referred to as a transacting business description), and to which customer account the transaction medium is associated. In one example, the transacting business description may include a title/name of the transacting business, the address of the transacting business, a time and date of the transaction, information relating to a point of sale device used to conduct the transaction, or other data associated with conduction of the user purchase which may be used to uniquely identify a transacting business. Purchase details may further comprise information identifying which user account on the loyalty platform to associate with the user purchase. As described further, herein, purchase tracking 122 may be configured to link to credit cards, debit cards, or any other trackable payment medium, and when the link is completed, the purchase tracking 122 may receive all purchase notifications made with that trackable payment medium (e.g. FIGS. 15-32). As an example relating to FIG. 2A, a user may make a purchase with the use of a credit card, tracked by purchase tracking 122, at a business. Additionally, a spend history/transaction history associated with each payment medium, and/or associated with each user account (in the case that a user account is associated with multiple linked payment media), may be generated for linked payment media and stored in non-transitory memory of the rewards platform. In one example, the reward policies of a business stored on the loyalty platform may take into account the transaction history of a user when determining the amount of the equity reward to allocate to the user. In one example, determining the amount of the equity reward to allocate to the user comprises increasing a percentage of a monetary value of a user purchase used to reward the user based on a cumulative monetary value of user purchases from the rewarding business increasing beyond a threshold, wherein the threshold may be defined in the reward policies of the business and the cumulative monetary value of user purchases may be calculated on a rolling basis over a predetermined duration of time. In another example, based upon a cumulative transaction amount for a user with a single rewarding business within a finite duration of time increasing beyond a predetermined threshold amount, the amount of the equity reward allocated to a user as a fraction of the total transaction amount may increase. As an example, the transacting business may be listed within markets 156 (further shown in FIG. 6)

At 204 the loyalty platform may employ a purchase tracking system or module to identify the business and the user involved in a user purchase. The payment medium used in the user purchase may be uniquely associated with an account of a user on the loyalty platform, such as one of accounts 114 stored in the non-transitory memory 184 of computing system 180. In another example, the business with which the user conducted the transaction may be identified by the computing system implementing the loyalty platform by matching/correlating a transacting business description associated with the user purchase with a description of a business stored in the rewarding-business index of the loyalty platform. In one example, a match between a transacting business description and a description of a business stored in a rewarding-business index of the non-transitory memory of the computing system implies that the transacting business is registered with the loyalty platform, and therefore, that the user may be eligible for an equity reward based on the user purchase (note that in some examples the rewarding-business index may include an indication that the reward program of the registered business is cancelled or suspended, such as may be indicated by a flag included with the listing of the business in the rewarding-business index as previously discussed). In another example, if the computing system implementing the loyalty platform is unable to match the transacting business description with a description for a business stored in the rewarding-business index, this implies that the transacting business is not registered with the loyalty platform, and thus the user may be ineligible to receive an equity reward for the user purchase. In this way, for a user purchase identified by a purchase tracking system or module of a loyalty platform, such as purchase tracking 122, both the user and the transacting business may be rapidly identified using the system and methods of the current application, so long as the transacting business is registered with the loyalty platform. Further, it may be quickly ascertained if the tracked user purchase is eligible for an equity reward. And in some examples, in the event that the user purchase is not eligible for an equity reward, the computing system implementing the loyalty platform may transmit a notification to a user computing device, for rendering on a display or communications interface of the user computing device, a notification to the user that their purchase was not eligible for a reward, the notification may further include an offer to the user to make a loyalty selection to one or more businesses stored a rewarding-business index of the non-transitory memory of the computing system which are actively offering equity rewards to loyalty selecting users

Moving to 206, the computing system implementing the loyalty platform may then execute a user loyalty lookup, comprising looking up the user's active loyalties stored in the account associated with the user. In one example the user loyalties, such as may be stored at user loyalties 126 of loyalty platform 108, may comprise recorded loyalty selections made by a user associated with an account stored within accounts 114, said account further associated with the linked payment medium used to conduct the purchase. In another example, a computing system implementing the loyalty platform may receive a loyalty selection from a user computing device, the loyalty selection comprising a user selection of a business listed in a rewarding-business index stored on the non-transitory memory of the computing system, the business listed in a market, and based upon the user selection of the business, the user is eligible to receive an equity reward associated with the business and is excluded from receiving equity rewards associated with unselected businesses in the market. The computing system may then conduct the process of storing the loyalty selection in a location of the non-transitory memory of the computing device associated with an account of the user, which may subsequently be accessed in order to determine if a user is loyal to a transacting business. In one example, loyalty selections may only be made to companies providing equity rewards to users through the loyalty platform, and thus listed in the rewarding-business index, as loyalty selections to other businesses would not enable the user to receive an equity reward, and thus the user would obtain no benefit from such a loyalty selection.

Proceeding to 208, the method determines if the user is loyal to any business in the market. If the user loyalty lookup returns that the user is loyal to a business or merchant or brand in the market, then the method proceeds to 201 of FIG. 2B, which will be explained in more detail below. As a further example, the user loyalty lookup may be executed by the purchase tracking 122.

If the user loyalty lookup determines the user is not loyal to any business in the market, the method proceeds to 210, where the purchase tracking 122 requests, or queries, loyalty manager 110 for available or offered user equity rewards with the transacting business. Additionally, at 210, the loyalty manager 110 may provide an option for the user to select loyalty in the market to the transacting business. The option provided by loyalty manager 110 may include information regarding loyalty policies 142 relating to the transacting business. The option provided by loyalty manager 110 may, in an example, include notifications of the rewards available to the user if the user should select the option for the user to select loyalty in the market to the transacting business.

Proceeding to 212, method 200 determines if the user has switched loyalty to the transacting business. If the user does select the loyalty-switch offer, the method may proceed to 216, wherein the user may earn the loyalty-switch offer. Additionally, as an example, the loyalty manager 110 module may update the user's loyalties at user loyalties 126 of accounts 114, by overwriting the previous loyalty selection of the user in that market, and the rewards manager 112 may update the user's current rewards at user rewards 128 of accounts 114. Furthermore, if the user accepts the loyalty-switch offer, the method may proceed to 203 of FIG. 2C. If the user does not select the loyalty-switch offer, the method may proceed to 214 wherein the user earns no equity rewards, privileges, or any other rewards which may comprise selecting the loyalty-switch offer and selecting loyalty to the transacting business.

Continuing now with FIG. 2B, at 218 method 200 includes determining if the user has made a loyalty selection to the transacting business. Determining if the user made a loyalty selection to the transacting business may include looking up the user's loyalties stored in accounts 114 at user loyalties 126 via purchasing module 122 executing the user loyalty lookup. If the user loyalty lookup returns that the user is loyal to the transacting business, and should therefore receive a reward according to the loyalty policies set forth, the method may proceed to 203 of FIG. 2C, explained in more detail below. If the lookup at step 218 determines that the user is not loyal to the transacting business, method 200 may then proceed to 220 where the loyalty manager 110 may present the user with a loyalty-switch offer which may include an option for the user to select a loyalty to the transacting business and terminate their previously-selected loyalty to another business in the market. As an example, the terms and policies of a loyalty-switch offer may be stored within loyalty policies 142. In some examples, loyalty-switch offers may include whole or fractional amounts of equity. In some examples, loyalty-switch offers may include equity rewards offered on transactions and/or discounts on transactions. In an example, loyalty-switch offers may be temporary or permanent or may be based upon any user behavior as defined by the business responsible for the loyalty-switch offer and/or the platform. In an example, loyalty-switch offers may include temporarily higher or increased equity rewards for transactions executed with the transacting business.

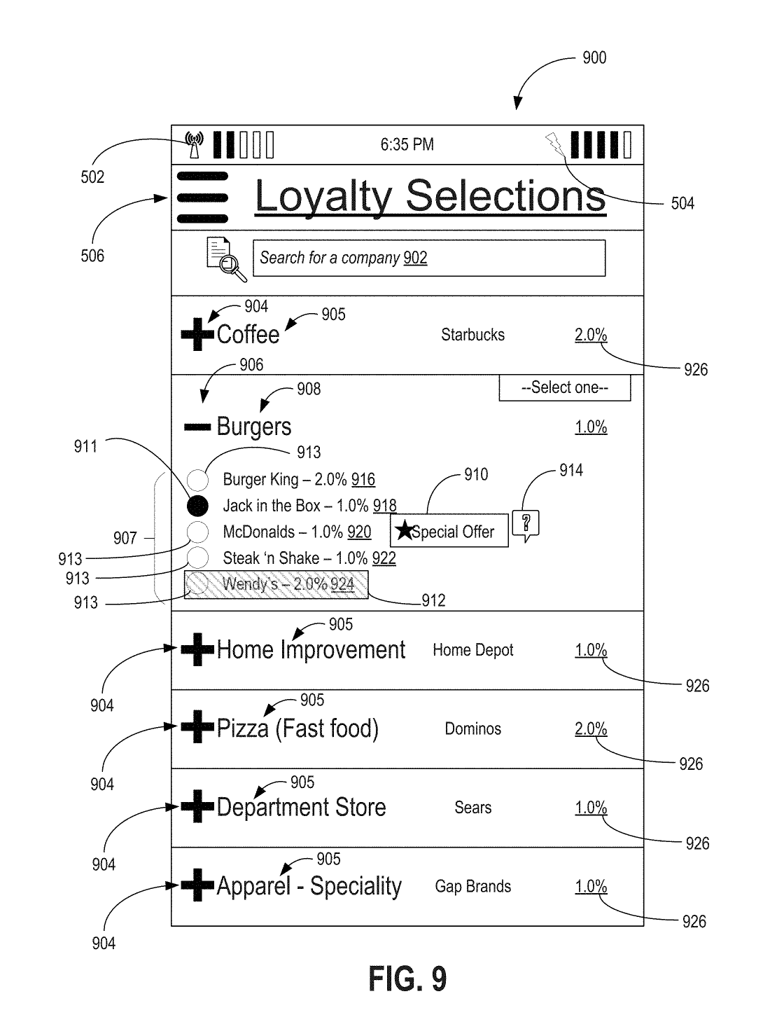

Additionally, loyalty-switch offers may be presented, offered, or made available to the user at any time, for example, when the user is browsing through available loyalty selections, further illustrated at FIG. 9, or as another example, at any desirable time when a user is interacting with the platform. In an example, a user who is conducting a transaction with a business, with which the user has not selected loyalty in a market, may receive a notification, for example via the purchase tracking 122 or loyalty manager 110. The purchase tracking or loyalty manager may inform the user that they are not receiving equity rewards at the business where they are conducting the transaction. In some cases if the user is merely present within, at, or near a business listed in the rewarding-business index to which the user does not have an active loyalty selection, the notification may further include a loyalty-switch offer so that the user may begin to earn rewards and/or privileges associated with the business. In one example, the user computing device may contain GPS capabilities, the computing system implementing the loyalty platform configured to receive the location of the device therefrom, and to correlate the location of the user computing device with predefined location information specified for one or more of the plurality of businesses in the rewarding-business index. Thus, the computing system implementing the loyalty platform may be enabled to ascertain when the user computing device is within a threshold distance of one or more businesses registered with the loyalty platform, and therefore listed in the rewarding-business index. In one example, based on the user computing device being less than a threshold distance from one of the plurality of businesses listed in the rewarding-business index, an offer for a loyalty selection to the said one or more businesses may be transmitted to the user computing device, for display via a display or communications interface of the user computing device. In a further example, based on a location of the user computing device, and a local time of the location of the user computing device, and the spend history of one or more payment media associated with the user, a customized loyalty-switch offer may be transmitted to the computing device of the user. In another example, the threshold distance may be a predetermined distance, such as 1 mile. In other examples, the threshold distance may be based on a rate of user travel, or an estimated travel path of the user as indicated by a derivative of the position signal being transmitted to the loyalty platform.

After presenting the loyalty-switch offer to the customer, at 222, the method 200 continues where the purchase tracking 122 queries loyalty manager 110 and/or user loyalties 126 to determine if the user has switched loyalty to the transacting business. If the user does not switch loyalty to the transacting business and declines the loyalty-switch offer, the method 200 may proceed to 226 where the user earns no equity rewards for the transaction. Contrastingly, if the user does switch loyalty to the transacting business, the method 200 may proceed to 224 where the loyalty manager 110 may update the user's loyalties at user loyalties 126 of accounts 114. The method may further include the rewards manager 112 updating the user's rewards 128 of user account 172 to include the privileges and/or benefits of the loyalty-switch offer. After the user account (for example, user account 172) has been updated, the method 200 may then proceed to 203 of FIG. 2C. As an example, if a user has selected loyalty to a first business but then selects loyalty to a second business via a loyalty-switch offer, the purchase tracking may update user loyalties 126 to include information that the user has now canceled loyalty or loyalty selection to the first business and selected loyalty to the second business

Turning now to FIG. 2C, the variable reward modifier 154 may also provide modified rewards to the user based upon random selection. At 228 of method 200, the purchase tracking 122 may have tracked a purchase between a user and a business with which the user has made a loyalty selection. The purchase tracking 122 may communicate with the variable reward modifier 154 per each transaction tracked by loyalty platform 108, and furthermore the variable reward modifier 154 may include a random selection algorithm 162 which may be invoked to randomly provide modified rewards to the user. As an example, the random selection algorithm 162 may be implemented within the variable reward modifier 154 and the variable reward modifier 154 may further include variable reward policies 164 which include rules and/or instructions for how to provide variable rewards

At 230, the variable reward modifier 154, as an example, may invoke the random selection algorithm 162 to determine if a tracked transaction (made between a user and a transacting business wherein the user has selected loyalty to the transacting business) may or may not receive a modified reward, and the variable reward modifier may also modify the reward based upon variable reward policies 164

At 232, if the tracked transaction is determined to receive a modified or variable reward, the method may proceed to 244 wherein, the variable reward modifier may apply variable reward policies 164 to the normal reward. At 244, the variable reward modifier may run a user loyalty lookup to determine the reward, or normal reward, associated with selected loyalty to the business based upon reward policies 144. At 232, if the tracked transaction is not determined to receive a modified or variable reward, the method may proceed to 234. Similarly, at 234 the variable reward modifier may run a user loyalty lookup to determine the reward, or normal reward, associated with selected loyalty to the business based upon reward policies 144

The variable reward policies 164 may contain instructions and/or rule sets related to the modifications of the normal reward of any tracked transaction based upon the results of the random selection algorithm 162 having determined the tracked transaction may receive a modified reward. In an example, a variable reward policy may include a modification policy which may invoke the random selection algorithm 162 yet again to determine, by random selection, a degree of modification from a list of possible modifications. In an example, the variable reward policy may include the modification policy comprising a list of possible modifications comprising reward multipliers, for example, 2×, 3×, and 4×. By invoking the random selection algorithm 162 to choose, by random selection, from the list of possible reward modifications (for example, multipliers 2×, 3×, and 4×), the variable reward policy may randomly select a reward modification, and in such an example, if a 3× reward multiplier were chosen, then the reward amount, (for example, equity reward) which may be given to the user as a discount charged to the merchant, may be multiplied by 3. In an example, a user may execute a $100 tracked transaction with a business the user has selected loyalty to. With no reward modification, the user may normally receive a 1% discount via the loyalty platform 108. However, if the user may be determined to receive a variable reward including, for example, a 3× reward multiplier (in accordance with the variable reward policies 164), then the user would receive a 3% discount which would then be charged to the transacting business (along with the service charge, which may or may not also be modified by the reward modification). Furthermore, the user may be assigned $3 worth of fractional or whole shares of equity in the transacting business via the equity allocation system 120

If, the variable reward modifier 154 applies reward modification policies to the normal reward at 244, next, the method 200 may then proceed to 246 and the variable reward modifier 154 may provide the modified and/or variable reward (the normal reward of 128 with variable reward policies 164 applied to it) to the user, in the form of a discount at the point of sale. In another example, the user may receive the variable reward not as a discount, but as a reimbursement of funds sent to user funds 160 or an account with payments 150

At 248, purchase tracking 122 may charge a transacting business a cumulative rewards charge wherein the cumulative rewards charge includes the value of the modified reward and a service charge. As an example, the service charge may be a fee charged by the equity allocation system 120 of loyalty platform 108 for brokering the equity reward. The service charge may be a percentage of the total transaction dollar amount or it may be a flat dollar fee.

At 250, the purchase tracking 122 may request the equity allocation system 120 to issue a buy order with clearing system 104 for equity of the transacting business proportional to the amount of the modified reward. Once clearing system 104 settles the transaction, at step 252, assign module 148 of equity allocation system 120 may update user equity 130 to include the assigned equity. In other words, at 252, the computing system implementing the loyalty platform may perform the step of allocating an amount of the equity reward to the account of the user via an equity allocation system based on the transacting business description matching a description of the business selected by the user in the loyalty selection, the amount of the equity reward further based upon one or more of the transaction amount, a transaction history of the user, and loyalty policies of the business selected by the user and further, transmitting the amount of the equity reward to the user computing device for rendering within a user interface implemented at the user computing device the amount of the equity reward and an updated cumulative balance of the equity reward allocated to the account of the user.

Returning to 232, if the invocation of the random selection algorithm determines that the tracked transaction may not receive a modified reward, then the user may receive a normal reward (without modification) based upon the user rewards 128 of the user account 172, and steps 234-242 are the same as 244-252, where only a normal reward is provided instead

In an example, a reward which may be given in equity may be stored at user equity 130. In a further example, if a tracked transaction is determined to not receive a modified reward the user may receive the normal reward stored at user rewards 128. The example set forth above and herein may provide incentive for users to repeatedly shop (or increase number of transactions) and spend more money at businesses which they have selected loyalty to as they may unexpectedly receive modified (greater) rewards, in some cases equity rewards. In such an example, users may exhibit increased loyalty to stores where they are occasionally rewarded with greater rewards

As an example, a reward may comprise at least a purchase discount on a transaction executed with a business the user has selected a loyalty to. As an example, the purchase discount may comprise a dollar amount or a percentage discount on purchases with the transacting business. In a further example, the reward may also include an equity reward. As an example, the reward may further comprise an equity reward which may comprise a percentage of the transaction dollar amount, or in some examples, a set, established dollar amount. In some examples, the equity reward may further comprise a variable percentage of the transaction dollar amount or a variable dollar amount. As an example, a service charge may be a fee charged by loyalty platform 108 for brokering the equity reward, and the service charge may be a percentage of the total transaction dollar amount or it may be a flat dollar fee

In some examples, the method may include determining a reward based upon any one or any combination of: the loyalty selection, a transaction history of the user, and a variable reward modifier 154. As an example, if the user has not made a loyalty selection to the transacting business, then the user may not receive any reward. If the user has made a loyalty selection to the transacting business, then the user may receive a reward. Furthermore, based upon the loyalty policy (stored in loyalty policies 142) of the transacting business, the reward may be modified based upon a transaction history of the user 132 and/or the reward may be modified based upon a user payment method 134 and/or the reward may be modified based upon the variable reward modifier 154. For example, if a user meets certain criteria based upon past transaction history with the transacting business, then the user may receive a modified award. Furthermore, as an example if a user increases their spending, e.g., the frequency of transactions and/or amount of money spent per transaction, the user may receive a greater reward. Furthermore, as an example, if a user decreases his or her spending, the user may receive a lesser reward. In some examples, a modified reward may comprise a modified equity reward percentage wherein the percentage of the transaction monetary value put towards equity rewards is modified based upon transaction history and/or loyalty history. In some examples, a modified reward may comprise an equity reward percentage, as disclosed above, as well as a set amount of equity (either fractional or whole shares). As an example, rules and/or instructions for modifying rewards based upon transaction history or user behavior or user history, as mentioned above, may be included in variable reward policies, and these modifications may not depend upon the invocation of the random selection algorithm 162.

As a further example, if a user uses a particular credit card or particular payment method, which may be promoted or preferred with respect to the transacting business, then the user may receive a modified reward based upon a modification policy applying, wherein the modification policy applies a reward modifier to the reward based upon the payment method used for the transaction. Furthermore, at 308, the reward may be further modified by the variable reward modifier 154, then proceeding to 310, the reward may be provided to the user and added to one or more of user equity 130 and user funds 160

FIG. 3 is a graph 300 which illustrates equity percentage over time for one exemplary user (e.g., user 102) for multiple businesses in multiple markets. Graph 300 illustrates, as further explained herein, changes in loyalty over time between businesses in different markets and provides some examples of how user history and behavior may effect rewards. As an example, the rewards illustrated in FIG. 3 are percentage equity rewards wherein the equity reward is provided as a number of shares (either fractional or whole) equivalent in value to a percentage of a transaction value. Legend 302 provides graphical representations of percentage equity rewards of different companies 304, 306, 308, and 312 provided as examples in FIG. 3. As shown, Company A in Market 1 is designated by triangle-line 304, Company B in Market 1 is shown by X-line 306, Company C in Market 2 is shown by square-line 308, and Company D in Market 3 is shown by star-line 312

As an example, the user may make a loyalty selection at year 1 to company A, as shown at 314. At 314, for example, the user may receive an introductory reward at 1.0%. As shown in the graph, the user may receive higher equity rewards over time. As an example, the user may receive increased equity rewards over the introductory reward, wherein as an example the user's equity rewards with Company A may increase by 0.25% every year up to year 4. As an example, a user may or may not receive the same rewards adjustment (either increase or decrease) at every time interval. The adjustments made over time to equity reward percentages may be administered in reward policies 144 of the rewards manager 112, and furthermore, rewards manager 112 may update user rewards 128 so the user may readily access their available rewards

As a further example, at 316, the user may make a loyalty selection at year 3 to Company C in Market 2 308. As Company A and Company C are in different markets, the user may have loyalty to both companies simultaneously. As an example, Company C may provide a slightly adjusted equity rewards policy, as shown in the graph, such that the user may earn a 0.5% increase in equity reward percentage, but only after two years. In some examples, some rewards policies may have longer or shorter wait times before equity rewards are increased.

Looking to year 4 of graph 300, the user, whose loyalty in market 1 was to Company A, may then switch loyalties to Company B market 1 306. The user may select a loyalty-switch offer at 320 which includes a temporary increase in equity rewards, which may be for promotional means. Company B temporarily provides a significantly higher level of equity rewards at 1.875% (show at 322) for 0.5 years, which may be a temporary or promotional offer, which in some cases may be part of a loyalty-switch offer provided to the user 102. At 324, the temporary or promotional adjusted equity reward may be reduced, however, at 326 the equity rewards for 306 may again increase in agreement with reward policies set forth at 144. As a further example, at 328, the user may switch loyalties again in market 1 selecting loyalty again company A 304. However, as an example, the user may, in some cases like shown at 328, receive a lower equity reward than the introductory reward as described above as a punishment for repeatedly switching loyalty within a market. As shown at 328, the user may receive less than 1.0% equity rewards for 304 at year 6 when they may have received 1.0% equity rewards at year 1 when they first selected loyalty to company 304. As an example, at 330, the user may receive rewards adjustments as administered by reward policies 144

Rewards adjustments as shown in FIG. 3, which may be stored at 144, relate to adjusting a user's rewards over time, however, in some cases, rewards adjustments may not be provided periodically, as with 304 and 306, but constantly. Turning to 334, at year 1 the user may select loyalty to company D in market 3 312 and the user may receive constantly increasing rewards along the line of 336, wherein in this particular example, the user may receive equity reward adjustments of 0.125% over 2 years. Such a constant increase in equity rewards may be more appealing to some users, while other users may prefer perhaps larger equity rewards adjustments given only periodically. In some cases, equity rewards adjustments like 336, may depend upon consumer spending. In some cases, any equity rewards adjustments, for example 336, may only occur if the user's meet certain transactional criteria (for example, spending) wherein the transactional criteria may be stored in reward policies 144. As an example, at 338 the constant increase in equity rewards for 312, which was observed at 336, has now ended. As an example, at 338 equity rewards adjustments per reward policies 144 may not allow for any equity rewards increases as the user may not be meeting a spending threshold or meeting any applicable spending criteria included in 144. As a further example, a user's equity rewards adjustments may further comprise 340 wherein a user's equity rewards may be reduced if the user's spending continues to fall below the spending threshold or perhaps falls below a baseline threshold, below which a user's equity rewards may begin to decline. As an example, rewards may be adjusted by reward policies 144 and further viewable at user rewards 128 so that users may have a clearer understanding of their reward policies. As an example, reward policies 144 or rewards manager 112 may include criteria and/or thresholds for user activity, such as how much a user spends with a business over time or cumulative user transaction value over time associated with a business which may determine adjusting the user's equity rewards over time for the business.

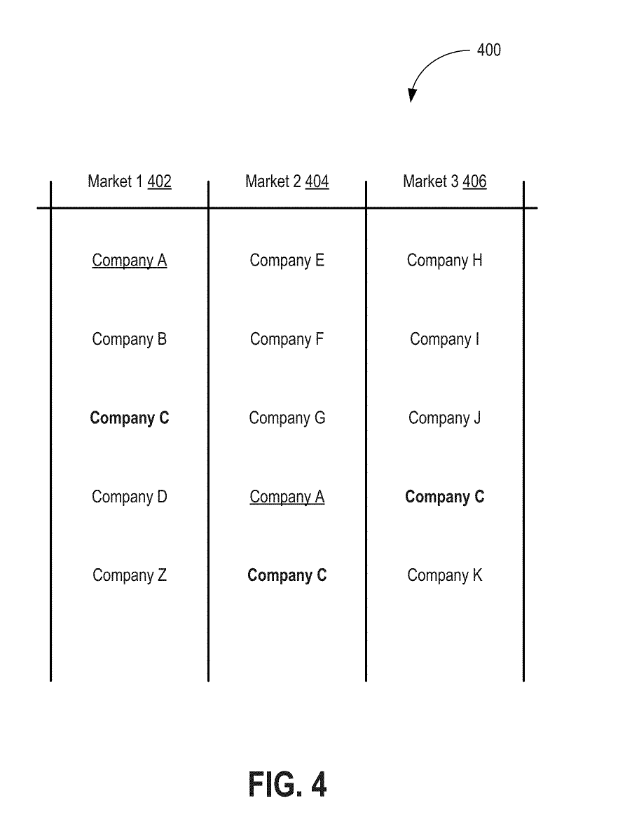

Turning to FIG. 4, an example table is shown representing markets 156 of loyalty platform 108, wherein a number of different companies may be listed (and/or multi-listed) across the available markets. As an example, Company A of FIG. 4 may be multi-listed across market 1 402 and market 404, and Company C may be multi-listed across market 1 402, market 2 404, and market 3 406. As an example, loyalty policies 142 may comprise instructions and/or rule sets for loyalty to businesses across markets. In an example, loyalty policies may allow a user 102 to select loyalty to Company A in Market 1 402 and also select loyalty to Company A in Market 2 404. In an example, reward policies for Company A in market 1 402 and market 2 404 may be the same, however, in some examples, the reward policies may be different. In an example, a user may be allowed to select loyalty to Company C across markets 402, 404, and 406, however in some cases, loyalty manager 110 may include loyalty policies 142 which include limits on loyalty selections per company across a plurality of markets 402, 404, 406. In a further example, markets 156 may include a market rule which may comprise limitations established by admin account 158 which determine how many loyalty selections a user may make per market. As an example, each market of markets 156 may have a unique market rule established by admin account 158.

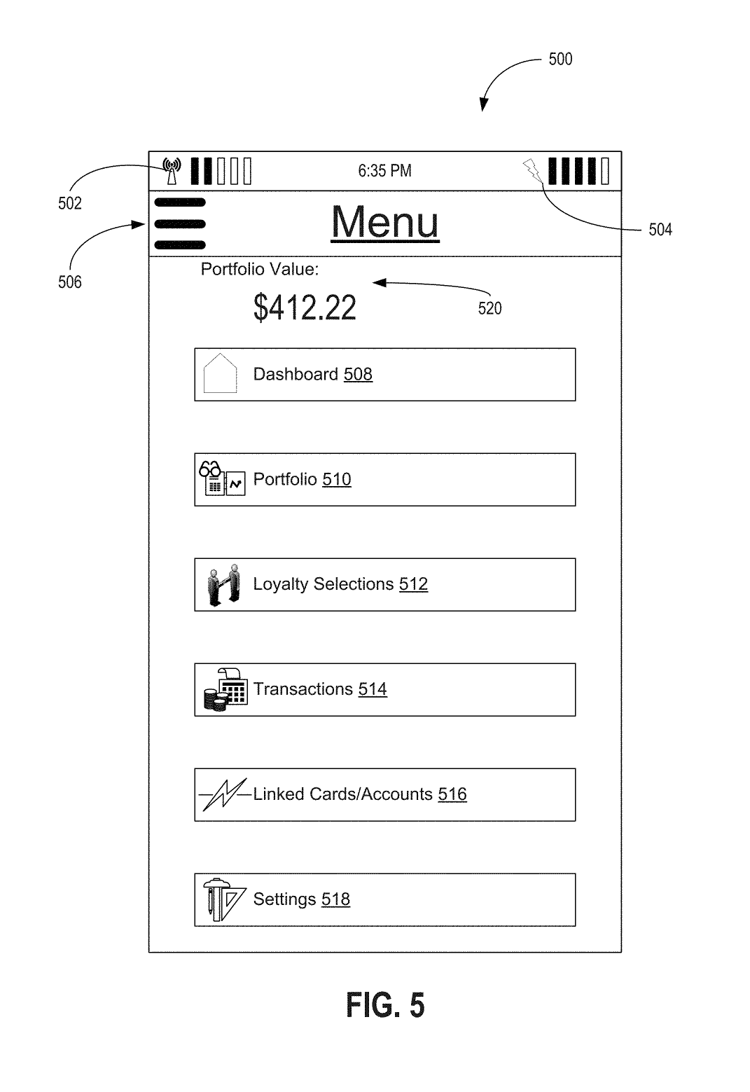

Turning to FIGS. 5-10 now, representations of exemplary graphical user interfaces (GUI) which may be displayed on a device of a user are shown. As an example, FIGS. 5-10 are shown as GUIs displayed on a mobile phone, however, the GUIs may be adapted to any computing device, mobile or stationary, interactive TV, heads-up display, virtual or augmented reality, or any other display comprising a user input functionality. In an example, the computing device of the user for viewing and operation of GUIs of FIGS. 5-10 may be connected to the Internet. For simplicity, FIGS. 5-10 may be discussed collectively

As an example, with respect to any and all figures described, when notifications, alerts, loyalty-switch offers, or otherwise are mentioned to be “displayed” or provided to the user, it may be understood that any notifications, alerts, loyalty-switch offers, or otherwise are sent from a computing device to be displayed or provided via a mobile phone, desktop computer, laptop, personal computer and/or computing device of any kind and may be displayed via a display.

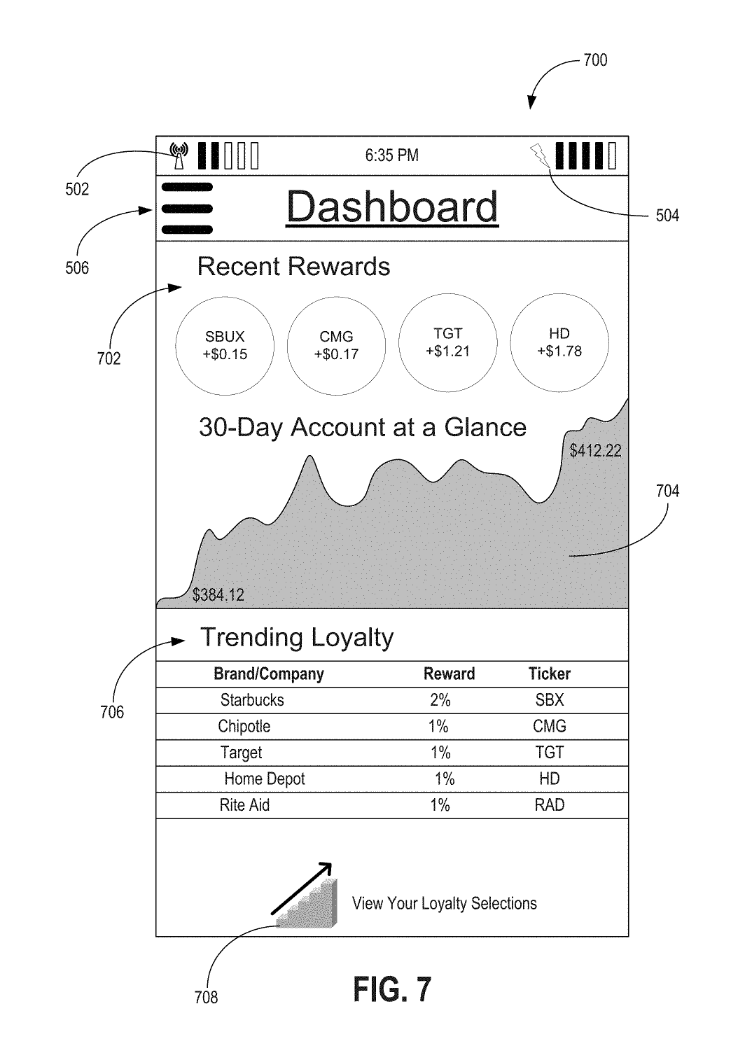

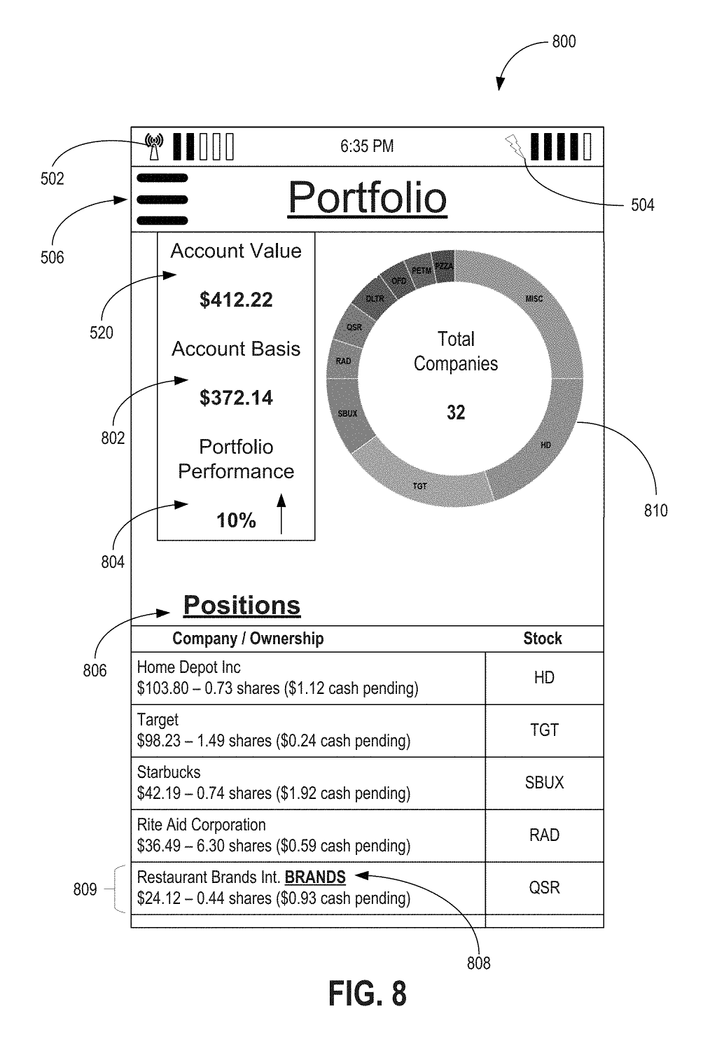

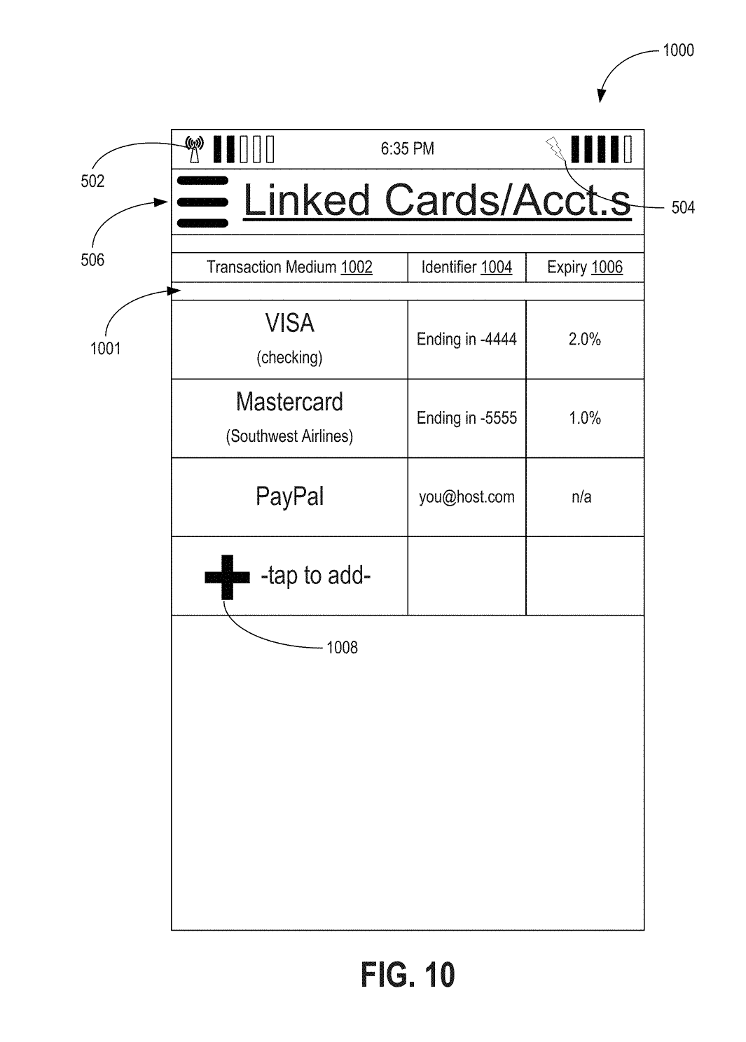

FIG. 5 is an example graphical user interface including a graphical user interface (GUI) 500 of a main menu screen for organizing user navigation of loyalty platform 108 on a computing device. As an example, GUI 500 is displayed on a mobile phone as indicated, as an example, by status bars 502 and 504 representing cellular communications tower or Wi-Fi reception and battery life status, respectively. GUI 500 may include a persistent menu button 506 as three horizontal dashes. Persistent menu button 506 may be displayed upon further GUI pages and upon a user's selection when other GUI pages are displayed, selection of the persistent menu button 506 may return a user to GUI 500. In an example, GUI 500 includes selectable elements 502-518 to navigate through the platform to access other linked GUIs such as Dashboard 508 (represented in FIG. 7), Portfolio 510 (represented in FIG. 8), Loyalty Selection 512 (represented in FIG. 9), Transactions 514 (represented in FIG. 6), Linked Cards/Accounts 516 (represented in FIG. 10), and Settings 518, though not limited to only accessing these. Additionally, GUI 500 may include a portfolio value which may comprise the total monetary value of user equity 130 and user funds 160

Turning now to FIG. 6, an example Transactions GUI 600 is shown. Transactions GUI 600 shows four exemplary transactions—a first, a second, a third, and fourth transaction, represented respectively by 602-610, 612-620, 622-630, and 632-640. The information populating the fields in GUI 600 may be retrieved by purchase tracking 122 accessing information stored within user account 172. In the first transaction, as an example, a timestamp 602 is shown including at least the date of an example tracked transaction/transaction via purchase tracking 122 and optionally (though not shown) a time of the tracked transaction/transaction. Element 604 provides an indication of value of a user reward, in the form of equity, added to user equity 130. Element 606 may display the total monetary value of a tracked transaction as well as the merchant and/or business with which the user may have conducted the tracked transaction. Element 608 may provide an identifier (in this particular example, a stock ticker symbol) for further identification of the merchant and/or business. Element 610 may display the reward which the user is currently entitled to via reward policies 144. As an example, elements 602-610 of the first example transaction show the user 102 receiving a reward of $0.15 604 which matches to the 2% reward 610 the user is currently receiving. In some examples, the reward 604 may be given in the form of fractional or whole shares, and the element 604 may represent the amount of fractional or whole shares the user may be rewarded with or the monetary value. As the user receives fractional or whole shares the portfolio value 520 shown in FIG. 5 may increase. As time goes on, in an example where they user receives fractional or whole shares of equity, the portfolio value 520 shown may fluctuate due to changes in value of equity based upon market trends. In such an example, equity allocation system 120 may additionally comprise instructions at updater module 147 to continuously update portfolio values 520 with current equity prices available via exchanges or clearing systems for a plurality of users, wherein the current equity prices may be based upon equity market trends

Continuing with FIG. 6, the second example transaction shown with elements 612-620 may illustrate, in contrast to the first example transaction, a return transaction having a timestamp 612 where the user may return an item, in this example, to Target. The user may sell or forfeit at least $0.22 worth of equity and/or rewards at element 614, or in some cases less than $0.22 worth of equity and/or rewards (if the share price has depreciated), and in some other cases more than $0.22 worth of equity and/or rewards (if the share price has appreciated), as part of a loyalty policy wherein returning money includes forfeiture and/or sale of equity. The total value of the item and/or items being returned may be displayed at element 616. A stock ticker symbol may be shown at element 618 for the business involved in the tracked transaction. At element 620 the transaction reward available to the user may be displayed. Loyalty policies of 144 may not depend upon returning equity and/or rewards, however, executing a return transaction may only entitle the user to a return of the transaction value less the value of the service charge and equity reward. However, as an example, loyalty policies of 144 may include forfeiture of rewards and/or equity wherein forfeit of equity may include transferring equity to platform account 136

Continuing with FIG. 6, the third example transaction is shown with elements 622-630 and may illustrate a user receiving a dividend via dividend distribution 152. A clearing system 104 or payments system 150 may communicate with dividend distribution 152 to alert loyalty platform 108 that KROGER (KR) 628 is scheduled to payout dividends wherein a user 102 may receive payout per share (fractional or whole) of the dividend payout. In an example, a user 102 may receive $0.02 dividend based upon having an amount of KR equity in the user equity 130. In an example, a $0.02 dividend may be added to user funds 160 as monetary cash value deposited in the user account 172 of the loyalty platform 108. In another example, a $0.02 dividend may be automatically re-invested in fractional or whole shares of the company which paid-out the dividend. As a further example, a dividend payment may be automatically deposited in a bank and/or payments 150 where a user may have a checking or savings or monetary account. Dividend payouts may increase the portfolio value 520 of a user 102. The dividend distribution of the third example transaction may include a timestamp 622. The value of the dividend added to user funds 106 may be displayed at element 624. Additionally, GUI 600 may include element 626 to display the name of the business which is distributing the dividend. Element 628 may further include a stock ticker symbol of the business from which the dividend is distributed. Element 630 “DIVIDEND” may be a selectable user interface object which may bring up a dialog box providing information about the dividend provided for the third transaction represented by elements 622-630.

Finally, with FIG. 6, a fourth example transaction is shown with elements 632-640 and may illustrate, in contrast to the other examples, a tracked transaction wherein the user is not loyal to the merchant/business with which they conduct the transaction. Element 632 shows a timestamp for a tracked transaction executed by an example user at a business the user is not loyal to. At element 634, the GUI 600 may show a strikethrough (or otherwise indicated canceled) reward of $0.42 offered as a reward for the transaction 636 wherein the user may have spent $42.15 at WALMART, however, as the user is not loyal and has not made a loyalty selection to WALMART, the user may not receive the reward of $0.42. As a further example, element 638 may display a stock ticker symbol for the fourth example transaction. Element 640 may indicate rewards available if the user had selected loyalty to TGT (as provided by loyalty policies 144)

In some implementations, a settling period may be provided by the dividend distribution 152 between the allocation of shares and the eligibility to receive dividends. The settling period may be used to correct for situations where goods are purchased, then subsequently returned (e.g., the staggering allows for the system not to be tricked into giving away dividends too quickly while transactions are still pending (e.g., are still able to be cancelled)). The settling period may be varied with the exchange policies associated with particular platforms, merchants or goods. In some implementations, no settling period is included, for example, when the purchase is for services or “as is” or “final” sales.

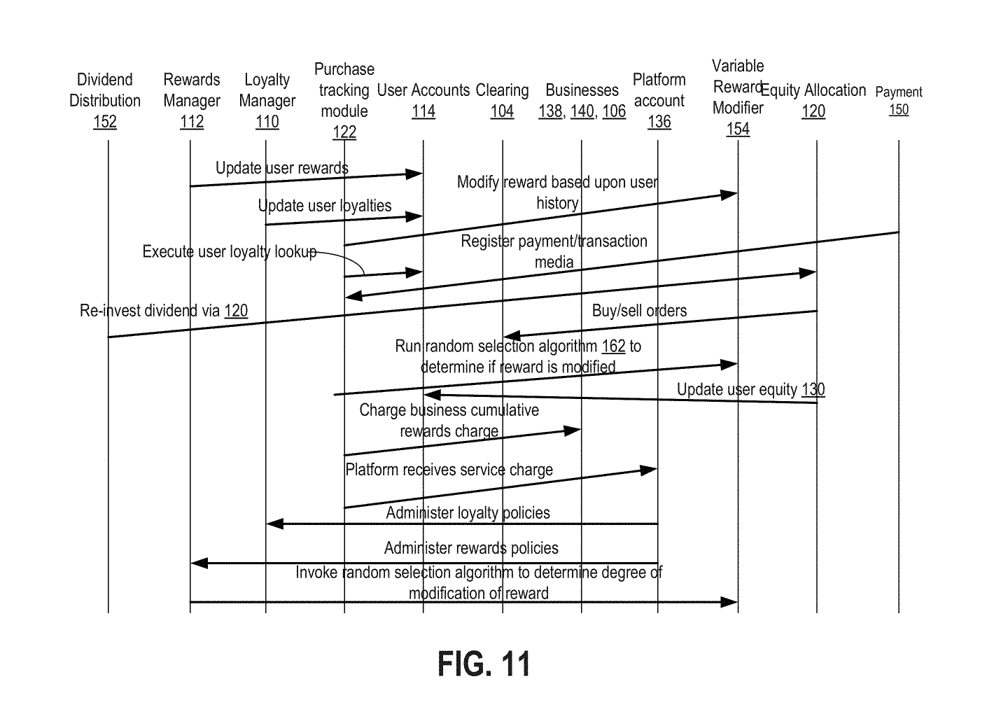

Turning to FIG. 7, an example Dashboard GUI 700 is shown which may present to the user at least recent rewards 702, a visual account summary 704, popular loyalty 706, and a link to Loyalty Selections (900 FIG. 9). Recent rewards 702 are shown depicting rewards which the user 102 may have recently earned via tracked transactions. GUI 700 also includes a visual account summary 704 showing a “30-day account at a glance” wherein the x-axis represents time and the line moving up and down along the y-axis represents account value for a user 102 and/or portfolio value 720. A table 706 shows brands/companies which have popular loyalty among a plurality of users 102, 116, 118, along with the respective rewards offered for those brands and their ticker symbols. Element 708 may be a selectable user interface element which directs the user to the loyalty selections (FIG. 11)

Turning to FIG. 8, an example user GUI Portfolio 800 is shown. As an example, as mentioned previously the account value 520 may be displayed for the user as well as an account basis 802. Account basis 802 may represent the amount of rewards accrued via tracked transactions for which the user has earned rewards. In an example, account value 520 may represent the adjusted value of the account due to appreciation or depreciation of equity and/or rewards in user equity 130 and user funds 160. Additionally, FIG. 8 may include an ownership GUI 810 which may provide an illustrated representing a make-up of user equity 130.

FIG. 8, furthermore, may include a table 806 including positions maintained by a user which may include a user's rewards and/or equity in different companies to which the user has made a loyalty selection. With entry 809 as an example, GUI 800 displays that the user may be assigned $0.44 shares in “Restaurant Brands Int.” worth a market value of $24.12. Additionally, entry 809 as an example may include a cash pending notification. As an example, the cash pending notification may inform the user via GUI 800 within table 806 that a purchase of (fractional or whole) shares having a value of $0.93 is pending, the shares to be assigned to the user

As a further example, GUI 800 may include 0.44 shares of Restaurant Brands Int. at element 808 within positions table 806 which may optionally include a multiple-company signifier, the “BRANDS” signifier 808 and/or interactive UI element 808 within the entry 809 in positions table 806. As an example, a user may make a loyalty selection to a brand and/or a company/business which owns many other companies. When a user makes a loyalty selection to a company/business which owns many other companies, the user may earn rewards in the name of the owning company/business when executing tracked transactions at the owned companies/businesses. In such an example, a user may receive rewards in a parent company, “Restaurant Brands Int.” when shopping at any of the “BRANDS” 808. The user may select element “BRANDS” 808 to view the available companies/businesses with which a tracked transaction may earn the user rewards in the owning company (for example, “Restaurant Brands Int.”). In a further example, any desirable UI element may be used for 808 (for example, image or text or combination image and text)

Turning now to FIG. 9, an example user loyalty selections GUI 900 showing available loyalty selections is shown. As an example, GUI 900 may provide a search function so that a user may perform a search for a company, business, and/or brand, wherein the search may return the company, business, and/or brand and the user may select loyalty or switch loyalty (via selection of a loyalty-switch offer) to. As an example, the search function may return results from loyalty manager 110, specifically markets 156. Expandable UI elements 904 may be provided and upon selection may provide a list of businesses (for example, 907) in the markets 905, wherein the markets may segregate business by function, offering, primary sales, types of sales items, etc. or any desirable theme administered by the loyalty platform 108 via administrator account 158. Collapsible UI elements 906 may be provided to collapse a list 907 of businesses in an expanded market 908 (for example, where all business of the market are displayed, including businesses 916, 918, 920, 922, and 924). As an example, list 907 may include a highlighted UI element 911 to indicate a business/merchant to which the user may have selected a loyalty to. List 907 may include non-highlighted UI elements 913 having the same shape as UI element 911 to indicate businesses/merchants which the user may not have selected loyalty towards in the same market 908 as the business/merchant represented by 911 UI element. UI element 912 may be included to indicate business/merchant 924 which is not yet available for a user to select loyalty to (for example, may be pending approval via administrator account 158). As a further example, business/merchant 920, in an example “McDonalds”, may include a “special offer” element 910 which may comprise a loyalty-switch offer. Furthermore, special offer element 910 may also include a help dialog 914 which may explain any loyalty-switch offer promotion terms or provide comparative information related to switching loyalties within a market. Additionally, as an example, special offer element 910 may provide current reward display 926 which may inform and/or display to the user the current reward which the user is entitled to via the loyalty selection made to a business/merchant in a market 905, 908

Continuing to FIG. 10, an example Linked Cards/Accounts GUI 1000 may include table 1001 which provides a summary for an example user account 172 representative of payment methods and media stored within payment medium storage 124. Table 1001 may include columns for payment medium 1002, Identifier 1004, and Expiry 1006. Column 1002 may include names or payment/payment media and with which transaction/credit enterprises the payment/payment media function. Identifier column 1004 may include identifiers for different payment media. Expiry column 1006 may include expiration dates for a plurality of payment media described in column 1002. GUI 1000 may include interactive UI element 1008 which may allow a user to include additional payment methods and/or payment media

Referring now to FIG. 11, an example communication diagram 1100 is provided to provide further detail and clarity into the technical aspects of the reward program. Beginning with dividend distribution 152, when dividends are distributed by a company which a user has selected loyalty to, dividend distribution 152 may transfer those funds to equity allocation system 120 to re-invest the dividend value in the same position. In some examples, dividend distribution 152 may transfer dividend distribution funds to user funds 160, or in some cases, directly to payments 150 (e.g., a checking account).

Next, rewards manager 112 may update user rewards 128, comprising current rewards which the user may receive, of accounts 114 based upon any selected loyalties or loyalty switches to businesses. Additionally, if any reward policies 144 are modified or updated, rewards manager 112 may update user rewards 128 to include the most current rewards available

Loyalty manager 110 may update user loyalties 126, comprising current loyalties which the user has selected. If any loyalty policies 142 are modified or updated, loyalty manager 110 may update user loyalties 126 to include the most current loyalty policies.

Purchase tracking 122, upon tracking a purchase between a user and a transacting business which the user has selected loyalty to, may trigger the variable reward modifier 154 to run the random selection algorithm 162 to determine if a normal reward may be modified. Additionally, the purchase tracking 122 may charge a transacting business a cumulative rewards charge and provide the equity allocation system 120 with the reward funds and an order to purchase shares (to purchase equity for the user in the transacting business) and provide platform account 136 with the service charge funds. As an example, when purchase tracking 122 receives a notification that a user has executed a transaction through a linked credit card, debit card, or other payment method (e.g., a tracked transaction), purchase tracking 122 may execute, or run a user loyalty lookup and query accounts 114 (specifically user loyalties 126) to determine if the user has selected loyalty to the transacting business. Purchase tracking 122 may confirm registration of payment methods with payments system 150 based upon payment method registration and/or linking further described herein with reference to FIGS. 15-32. As an example, a user may register with the loyalty platform 108 and provide access credentials to purchase tracking 122 to be stored within payment medium storage 124. Purchase tracking 122, as an example, may register with payments 150 by providing the credentials entered by the user upon registering with loyalty platform 108.

Next, platform account 136 may administer and modify loyalty policies 142 as desired by an administrator of loyalty platform 108. Additionally, platform account 136 may administer and modify rewards policies 144 as desired by an administrator of loyalty platform 108

Next, equity allocation system may execute buy and sell orders with clearing system 104 based upon transaction information from purchase tracking 122. Additionally, equity allocation system 120 may update user equity 130 of accounts 114 when purchase tracking 122 provides equity allocation system 120 with the order to purchase shares in a transacting business that.

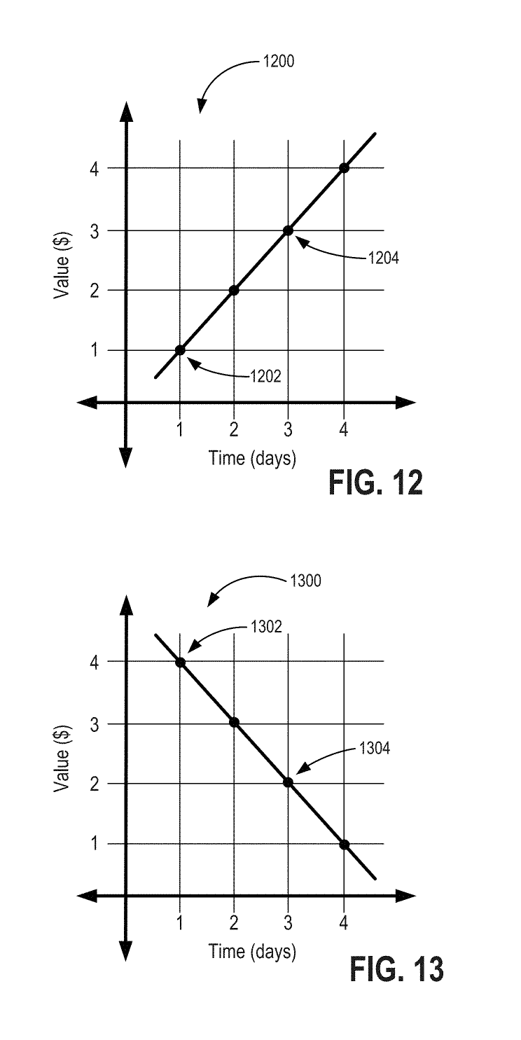

Proceeding to FIGS. 12 and 13, two exemplary graphs, 1200 and 1300, are provided to further illustrate and provide detail regarding forfeiture and sale of shares in the reward program. Referring to graph 1200 of FIG. 12, at 1202 a user may execute a tracked transaction at time 1 day wherein the value of the equity reward assigned to the user is $1 per share. As an example, the user may execute a transaction wherein the user spends $100 dollars. The user may be entitled to 1% equity rewards for the purchase and would receive $1 worth of equity or 1 share. Proceeding to day 3, wherein the value of the share may have appreciated to $3, the user may return the item at 1204 and forfeit the equity reward share, or the user may forfeit only the value of the share. In one example, the user may forfeit the same amount of equity given to the user as a reward on day 1, for example the user was assigned one share and must forfeit one share despite the increase in value on day 3. In another example, the user may forfeit only the value of the share, for example, the user was rewarded with one share on day 1 worth $1, which then on day 3 is worth $3, and as such, the user would only need to return a fraction of the share, for example, ⅓ of a $3 share (the value of the share they were assigned on day 1), due to the appreciation of the equity while assigned to the user

In another example, the user may elect to sell the shares at 1204 and may execute a sell order via the sell module 178 of the equity allocation system 120. In such an example, the user may earn $2 due to appreciation of the stock price and the total appreciated reward of $3 may be added to user funds 160

Proceeding to FIG. 13, a contrasting situation may be presented at graph 1300. On day 1, a user may execute a tracked transaction at 1302, spending $400 at a business with which the user has selected a loyalty and is eligible to receive 1% equity rewards. On day 1, the user may spend $400 and receive $4 in equity rewards, and as the value of the share is $4, the user may receive 1 share in the business. By day 3, however, the value of the equity has depreciated to $2 a share and the user may execute a return of the $400 goods at 1304. In such a return example, where the value of the equity has depreciated since the assignment of equity, the user may have to forfeit the whole share, though it may only be worth $2. In another example, if the user has been assigned additional equity in previous purchases, additional equity may also be forfeited in order to fulfil a forfeiture of $4 of equity rewards as the user received on day 1 of 1300 at 1302

In another example, the user may elect to sell the shares at 1304 and may execute a sell order via the sell module 178 of the equity allocation system 120. In such an example, the user may lose $2 due to depreciation of the stock price and the total reward of $2 may be added to user funds 160

In a further example, a user may not be assigned shares until a return period is over, such that, equity rewards may not be executed until a user may no longer return an item. In a further example, any forfeited shares may be sold via the clearing system 104 or assigned to the platform account 136 of loyalty platform 108

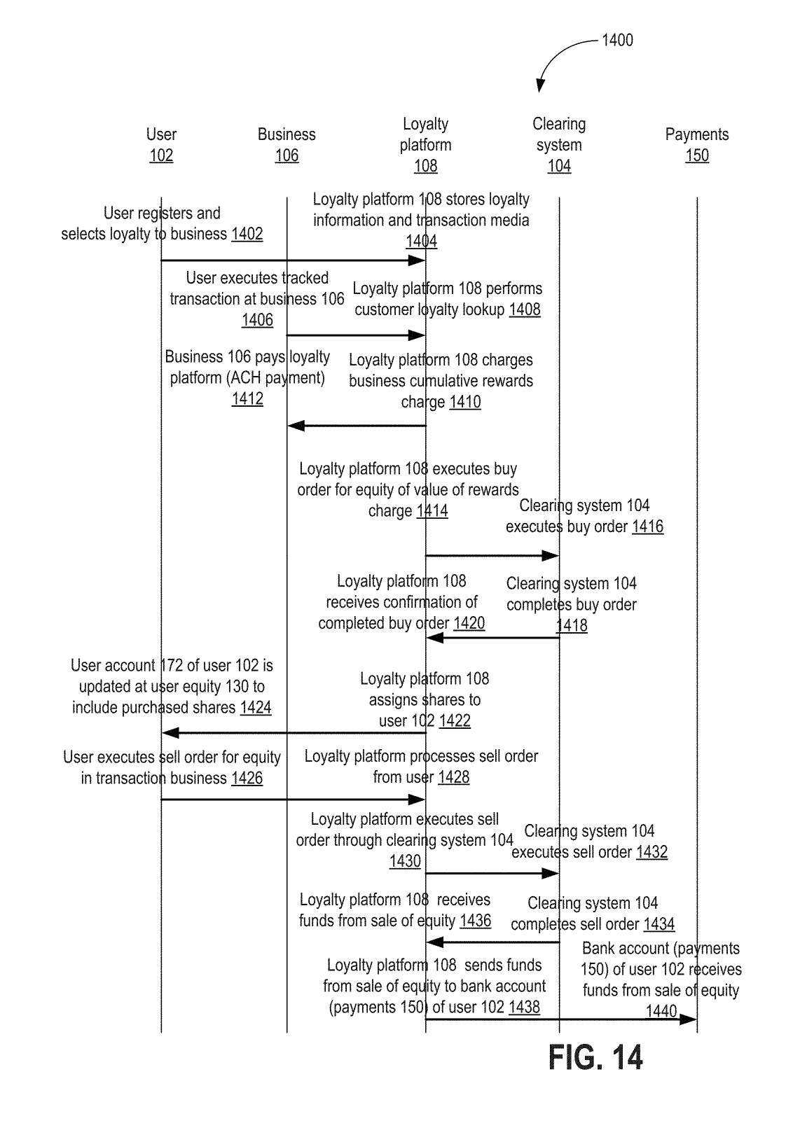

Turning now to FIG. 14, an example communication diagram illustrating communication between loyalty platform 108, business 106, user 102, clearing system 104 and payments 150. Beginning with 1402, a user may register with loyalty platform 108 and select loyalty to an example business 106. At 1404, the loyalty platform may store any loyalty information and payment media information related to banking accounts, credit cards, debit cards, online payment methods, or otherwise. At 1406, a user may execute a tracked transaction with a tracked payment media (tracked by loyalty platform 108) and the loyalty platform may then, at 1408, perform a user loyalty lookup to determine if the user has selected loyalty to the business and to determine the reward associated with selected loyalty to the business based upon reward policies 144. In an example, the user has selected loyalty to the business (where they made the transaction) and at 1410 the loyalty platform 108 then charges the business a cumulative rewards charge. At 1412, the business pays the loyalty platform 108 (for example, via ACH) the amount of the cumulative rewards charge. At 1414, loyalty platform 108 executes a buy order through the clearing system 104 where the buy order has a value of the rewards charge (cumulative rewards charge minus the service charge) for equity in the business. At 1416, the clearing system 104 executes the buy order. At 1418 the clearing system 104 completes the buy order and at 1420 the loyalty platform 108 receives confirmation of the completed buy order. At 1422, loyalty platform 108 assigns shares to user 102 having value of the rewards charge. At 1424, a user account (such as user account 172) or user 102 is updated (user equity 130) to include purchased shares

At 1426, in an example, a user may decide to execute a sell order for the equity rewards previously received. At 1428, the loyalty platform 108 may process a sell order from the user and then, at 1430, the loyalty platform 108 may execute a sell order through clearing system 104. At 1432, clearing system 104 may execute sell order and at 1434, the clearing system may complete sell order and send funds from sale of equity to loyalty platform. At 1436, the loyalty platform may receive funds from sale of equity and then, at 1438, send the funds from the sale to bank account, checking account, or desired payment method (payments 150) of user 102. At 1440, payments 150 associated with user 102 may receive funds from the sale of equity.

FIGS. 15-32 show example graphical user interfaces that may be displayed on a user device during an example user registration process for a reward program. As an example, FIGS. 15-32 may be discussed consecutively as each figure of FIGS. 15-32 may be ordered steps of a user registration process and the steps may be executed by accounts 114. Accounts 114 may store any information provided by a user during the registration process in user accounts such as 172, 174, 176. Additionally, accounts may also store any user information relating to payment methods with purchase tracking 122

FIG. 15 shows an example graphical user interface 1500 which may allow a user on a computing device to begin creating a user account, such as user accounts 172, 174, 176 of accounts 114 shown in FIG. 1A GUI 1500 may provide entry fields where a user may provide a user name and password for a user account, or user profile, so that the user may provide these credentials in order to log in to their account once the account setup and registration is complete. As an example, the user name may be a made-up name, an e-mail address, or any other identifier or account name associated with the user. Information provided to the entry fields in the GUIs discussed herein may be stored with the loyalty platform 108 and added to a user account of accounts 114. GUI 1500 may include a “Next” selectable user interface object, which when selected may advance the registration process to the next step of the user registration process.

FIG. 16 shows an example graphical user interface 1600 which may include an entry field where a user may provide a mobile phone number to include a mobile phone number with the user account. GUI 1600 may include a “Next” selectable user interface object, which when selected may advance the registration process to the next step of the user registration process.

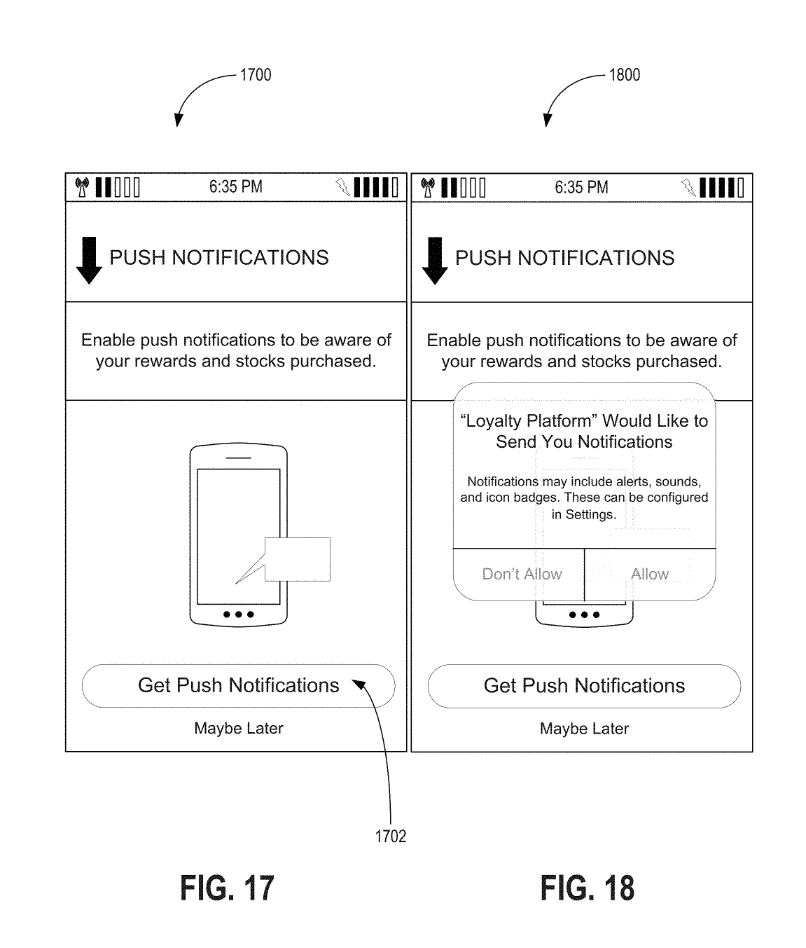

FIG. 17 shows an example graphical user interface 1700 which may include a selectable user interface object, wherein selecting the selectable user interface object may allow notifications to be sent from the loyalty platform 108 to a computing device of a user who has selected the selectable user interface object. GUI 1700 may include a selectable user interface object 1702 “Get Push Notifications”, which upon being selected, may allow the loyalty platform 108 to send push notifications to a user's mobile phone to provide updates regarding platform activity. As a further example, any appropriate notification may be sent to update a user, the notification not limited to e-mail, push notifications, telephone call, text message, or any other medium. GUI 1700 may include a second selectable user interface object, such as a “Maybe Later” button, which may allow a user to configure notification and notification sending through, as an example, the settings 518 menu of FIG. 5

FIG. 18 shows an example graphical user interface 1800 which may include an underlying graphical user interface similar to GUI 1700 with an added user interface object overlaid. Graphical user interface 1800 may be a confirmation step where a user may be requested, via the overlaid user interface object, to confirm that the user intends to receive push notifications (or other applicable type of notification) from the loyalty platform. The confirmation step may include a window with “Allow” and “Don't Allow” selectable user interface (UI) objects for the user to allow or not allow the sending of notifications to a computing device

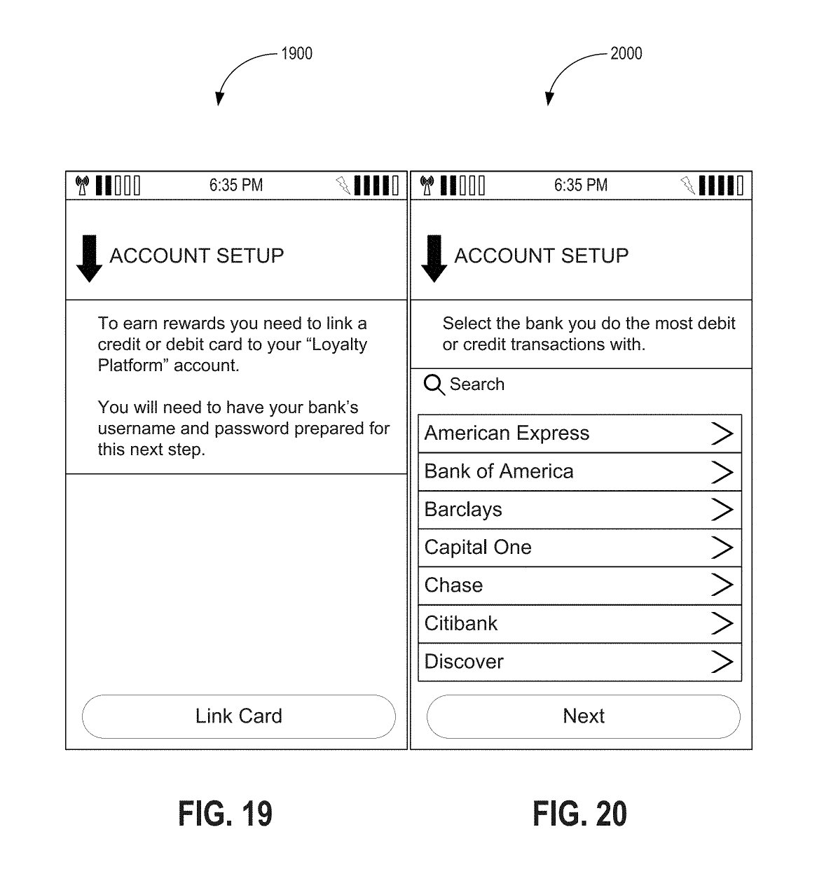

FIG. 19 shows an example graphical user interface (GUI) 1900 for a further account setup step related to linking a user's credit card, debit card, and on-line payment method with an associated user account on the loyalty platform. The linking of a user's payment method(s) with an associated user account may allow the purchase tracking 122 to store information regarding the payment method(s) and track user purchases. Additionally payment method(s) may be stored by accounts 114 in user payment 134 of a user account 172. GUI 1900 may include a selectable UI object such as a “Link Card” button, which may advance the user to the next step of the registration process, such as GUI 2000 of FIG. 20, to setup and associate any applicable payment method or payment medium with the user account associated with the user

FIG. 20 shows an example GUI 2000 for a user to link any appropriate payment medium with a plurality of selectable UI objects wherein each object may represent a different payment medium such as a credit card offered by AMERICAN EXPRESS, BANK OF AMERICA, or otherwise. Additionally, any of the plurality of selectable UI objects may represent a different payment medium such as an online payment method, for example, PAYPAL. As an example, the payment medium may not be limited to a credit card but may also include a debit card or any other type of payment platform which may be linked to the loyalty platform such as a checking account, savings account, or otherwise. The user may select one, or more than one, of the plurality of selectable UI objects at GUI 2000, and after selecting the appropriate selectable UI object(s) which may be associated with payment media to link to the user account, the user may select a “Next” selectable UI object. FIG. 20 may include a “Next” selectable user interface object. When selected, the “Next” object may proceed to the next step of the user registration process wherein the user may provide credentials associated with each payment medium to the loyalty platform 108, such that the loyalty platform 108 may gain access to the payment media linked to the user account.

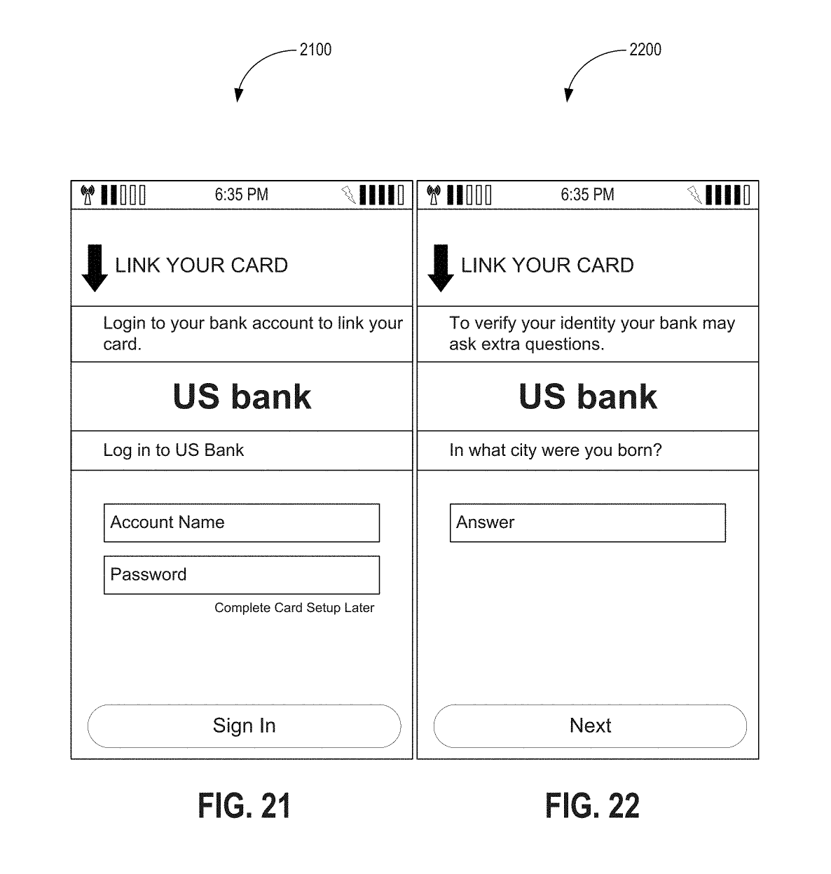

FIG. 21 shows an example GUI 2100 for a user to provide credentials or access information to be stored by loyalty platform 108 for any applicable payment medium. In an example, via GUI 2100, the user may provide log-in information such as a username or e-mail and password for a USBANK account. After providing the appropriate log-in information, the user the user may select a selectable UI object such as a “Sign In” button which may advance the registration process to the next step of the user registration process. At FIG. 22, after providing the log-in information for the payment medium, the user may be asked at example GUI 2200 to verify identity via security question. As an example, a user who may wish to associate more than one payment medium with the loyalty platform may need to repeat a process of providing log-in information at 2100 and answering a security question at 2200 for each of the plurality of selectable UI objects which may represent a different payment medium which the user may have selected at GUI 2000. GUI 2200 may include a “Next” button which may advance the user registration process to the next step of the process

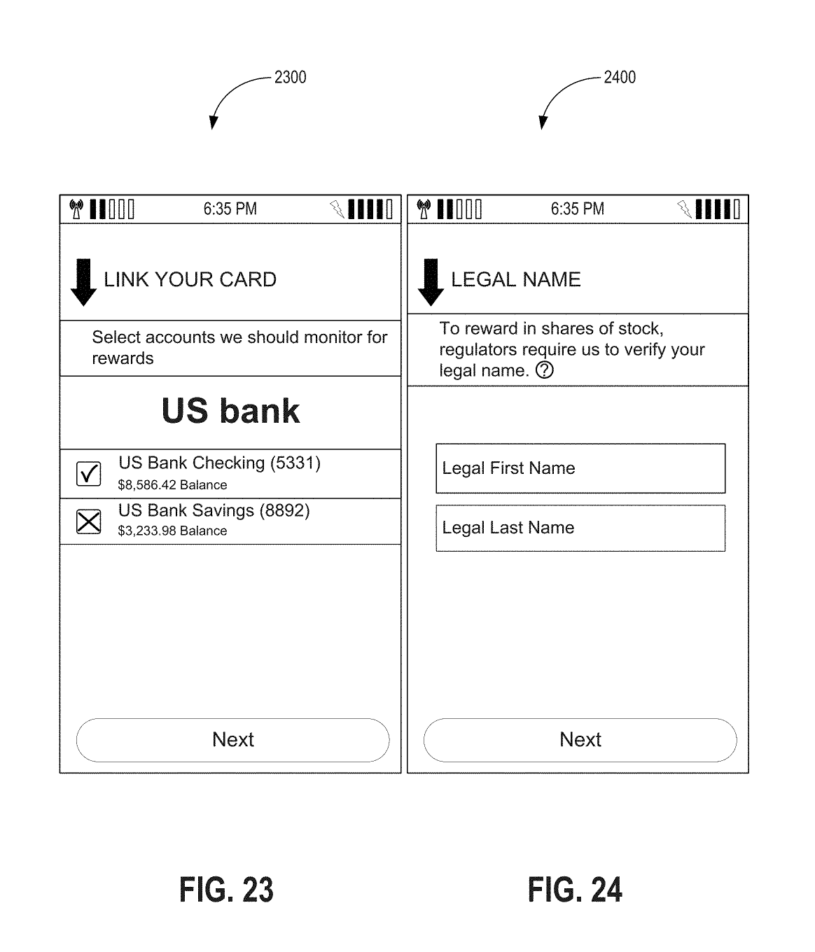

FIG. 23 shows an example GUI 2300 which may provide the user a selection screen where the user may select to link the one or more payment media with loyalty platform 108 via purchase tracking 122. As an example, a user may prefer to select multiple payment media for linking to the loyalty platform so that all their purchases via payment media (other than cash) may be put towards equity rewards on the loyalty platform. GUI 2300 may include a “Next” button which may advance the user registration process to the next step of the process.

FIG. 24 shows an example GUI 2400 which may include entry fields for a user to enter their legal first and last names for regulatory purposes as mandated by the SEC. GUI 2400 may include a “Next” button which may confirm the legal first and last names and advance the user registration process to the next step of the process.

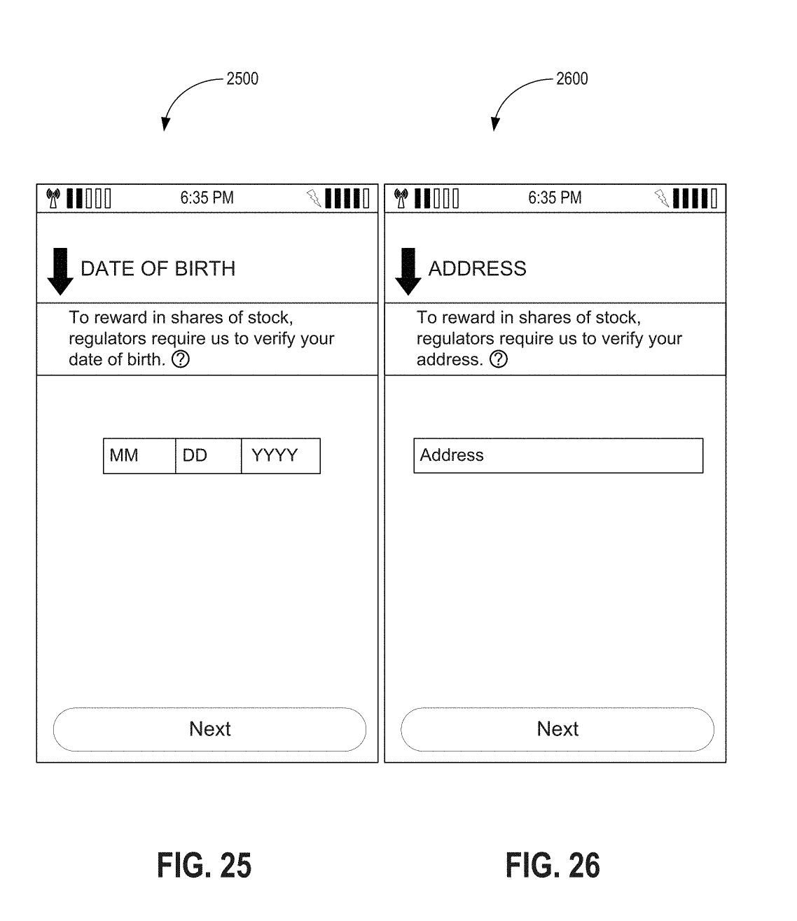

FIG. 25 shows an example GUI 2500 which may include entry fields for a user to their birthdate for regulatory purposes as mandated by the SEC. GUI 2500 may include a “Next” button which may confirm the birthdate and advance the user registration process to the next step of the process.

FIG. 26 shows an example GUI 2600 which may include entry fields for a user to enter their address for regulatory purposes as mandated by the SEC. GUI 2600 may include a “Next” button which may advance the user registration process to the next step of the process.

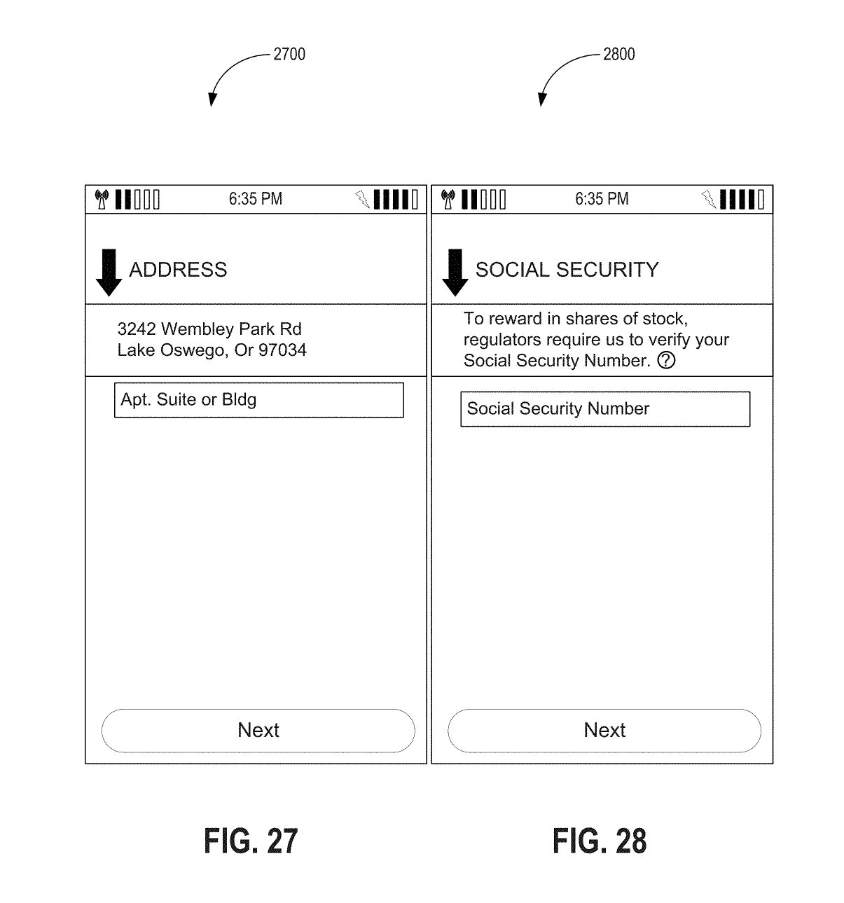

FIG. 27 shows an example GUI 2700 which may show a confirmation of the address which the user may have entered at GUI 2600. As an example, the confirmation may include a visual confirmation which may include a location shown on a map, wherein the map may be satellite imagery or street imagery. GUI 2700 may include a “Next” button which may confirm the address and advance the user registration process to the next step of the process.

FIG. 28 shows an example GUI 2800 which may include entry fields for a user to enter their social security number for regulatory purposes as mandated by the SEC. GUI 2800 may include a “Next” button which may confirm the social security number and advance the user registration process to the next step of the process.

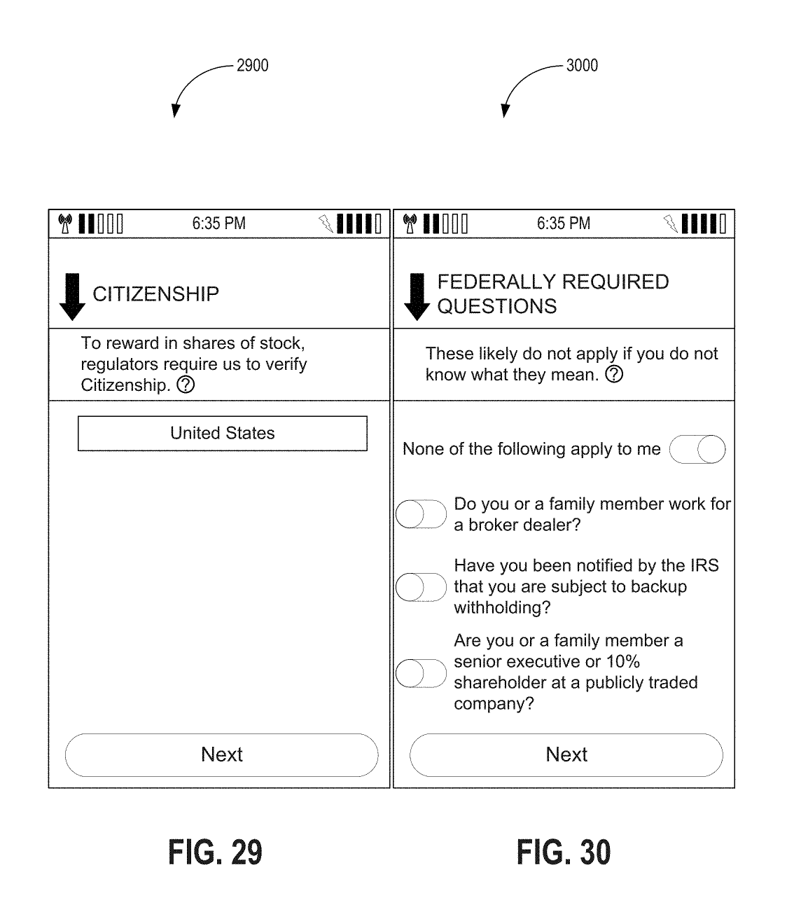

FIG. 29 shows an example GUI 2900 which may include entry fields and/or selectable UI objects for a user to enter and/or select their nation of citizenship for regulatory purposes as mandated by the SEC. GUI 2900 may include a “Next” button which may confirm the selection of citizenship and advance the user registration process to the next step of the process.

FIG. 30 shows an example GUI 3000 which may include selectable UI objects for a user to select to provide a yes or no answers to questions regarding personal or familial involvement in brokerage, backup withholding, and shareholding at a publicly traded company for regulatory purposes as mandated by the SEC. GUI 3000 may include a “Next” button which may confirm the question responses and advance the user registration process to the next step of the process.

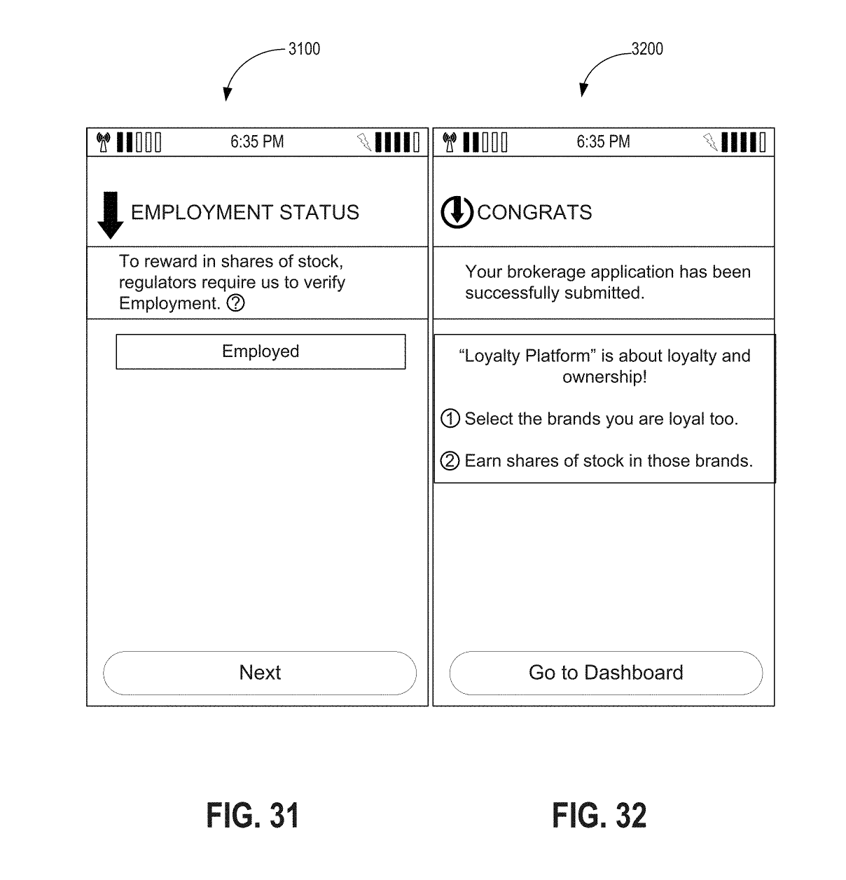

FIG. 31 shows an example GUI 3100 which may include entry fields and/or selectable UI objects for a user to enter and/or select their employment status for regulatory purposes as mandated by the SEC. GUI 3100 may additionally include a “Next” button which may confirm the selected employment status and advance the user registration process to the next step of the process.

FIG. 32 shows an example GUI 3200 which may include text instructions confirming the creation of a user account. As an example, GUI 3200 may also include a selectable UI object which may return a user to a dashboard GUI such as the one shown in FIG. 7

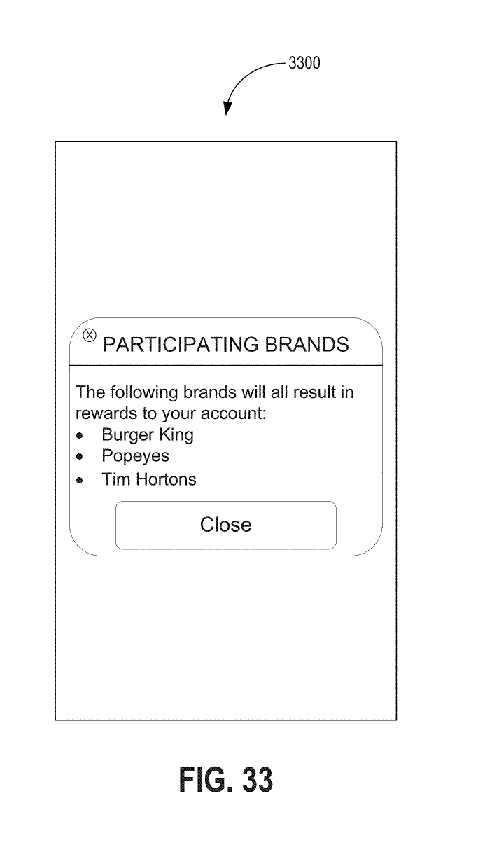

FIG. 33 shows an example Portfolio GUI 3300 which may be an updated Portfolio GUI 800 of FIG. 8. As shown in FIG. 8, element 808 (the “BRANDS” signifier) may be a selectable UI element, which, when selected by a user may bring up a Participating Brands dialog box, as shown in FIG. 33. A Participating Brands dialog box may include information about which businesses are bundled into a brand and which businesses an example user may execute transactions with in order to receive rewards. As an example, and as mentioned above, brands may be a collection of businesses which a user may select loyalty to. By selecting loyalty to a brand, a user may earn rewards when executing transactions with any of the businesses of the brand to which they have selected loyalty.

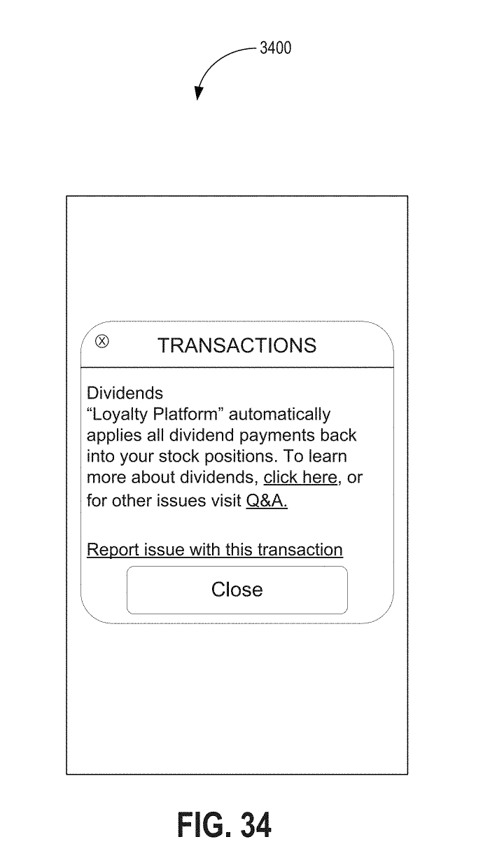

FIG. 34 shows an example Transactions GUI 3400 which may be an updated Transactions GUI 600 of FIG. 6. As mentioned above with reference to FIG. 6, element 630 “DIVIDEND” may be a selectable UI object, which, when selected by an example user may bring up a Transactions dialog box, illustrated in GUI 3400. The Transactions dialog box may include information regarding policies of the dividend distribution 152 and further information about how funds from dividends are handled. As a further example, any elements from FIG. 6 GUI 600 such as reward descriptions 610, 620, 630 and 640 may be selectable UI objects which, when selected by a user, may bring up the Transactions dialog box which may include any appropriate information regarding the reward with which that reward description may be associated.

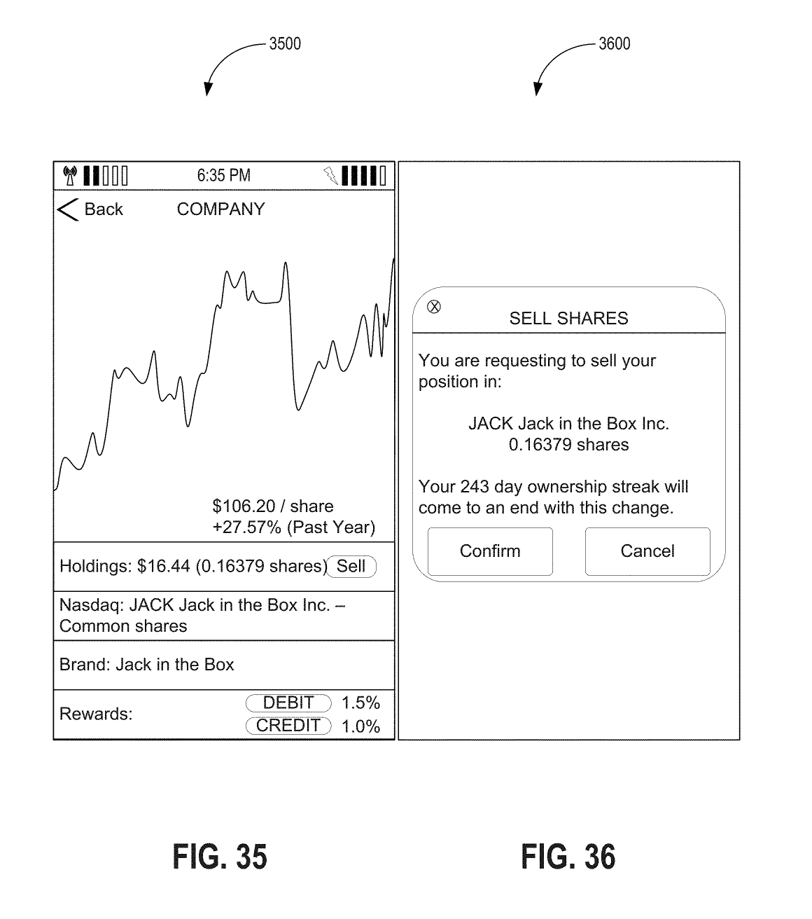

Next, FIGS. 35-39 may depict an example sell process. Turning first to FIG. 35 an example Company GUI 3500 is shown. A user may access a Company GUI 3500 by selecting a business name displayed via another GUI, such as any of the GUIs illustrated herein that include a business displayed thereon. Company GUI 3500, as an example, may include a graph showing the business's stock price over time, equity held by an example user, a Sell button, a stock ticker symbol (e.g., JACK for JACK IN THE BOX INC.), a brand to which the business belongs, and the available rewards. The Sell button may be a selectable UI object which, upon selection by the user, may bring up a first Sell Shares dialog box further shown in FIG. 36.

Turning next to FIG. 36, an example first Sell Shares dialog box is shown. Sell Shares dialog box may include “Confirm” and “Cancel” selectable UI objects which an example user may select in order to, respectively, sell a position in JACK or cancel a sale in JACK. In some cases, according to certain loyalty policies, a user may be forced to sell all equity in a position, while according to other loyalty policies, a user may be allowed to modify the number of shares the user wishes to sell in the position. The first Sell Shares dialog box may additionally include a loyalty notification which may inform a user that an ownership streak will come to an end if they sell all equity in a position. In an example, the ownership streak may be a length of time that a user has ownership in a position, or business. As an example, rewards policies may track ownership streak and based upon increasing ownership streak, a user may receive increased rewards. In an example, a user may select the “Confirm” selectable UI object and the sell module 178 of equity allocation system 120 may begin to execute the sell process with clearing system 104

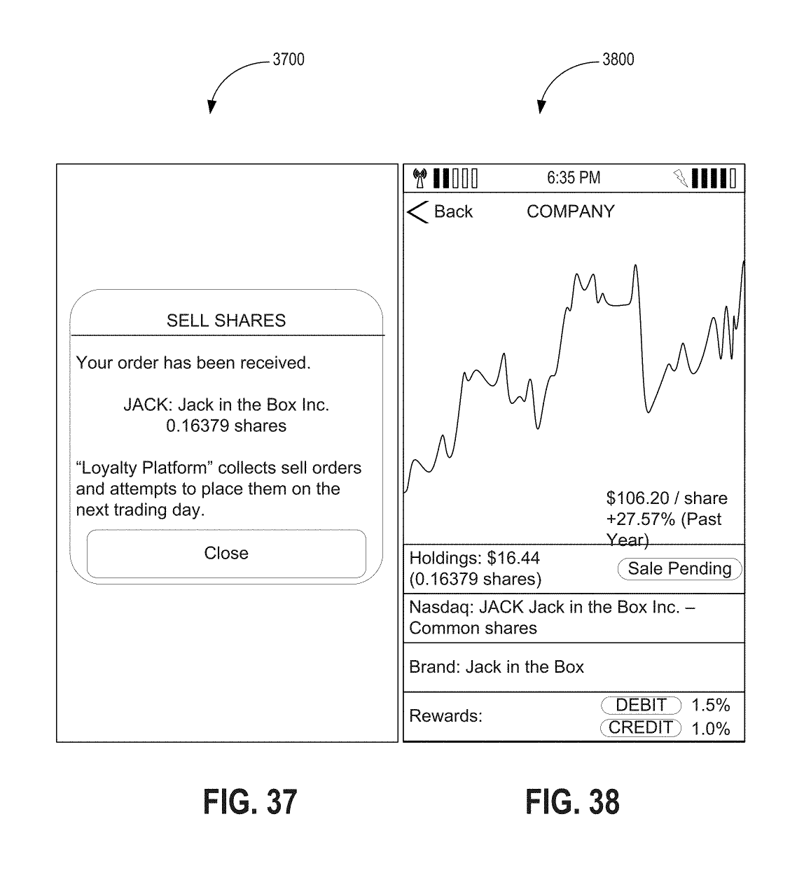

Turning now to FIG. 37, an example second Sell Shares dialog box is shown. The second Sell Shares dialog box may include a confirmation that the sell order has been received as well as a confirmation of the number of shares being sold. The second Sell Shares dialog box may include a “Close” selectable UI object, which, upon a user's selection, may return the user to an updated Company GUI 3800

Next, at FIG. 38 the updated Company GUI 3800 is shown where the Sell button has been replaced with a Sale Status indicator which may read “Sale Pending”. The Sale Status indicator may be a selectable UI object which a user may select to make modifications to the sell order. Selecting the Sale Status indicator may then bring up a third Sell Shares dialog box

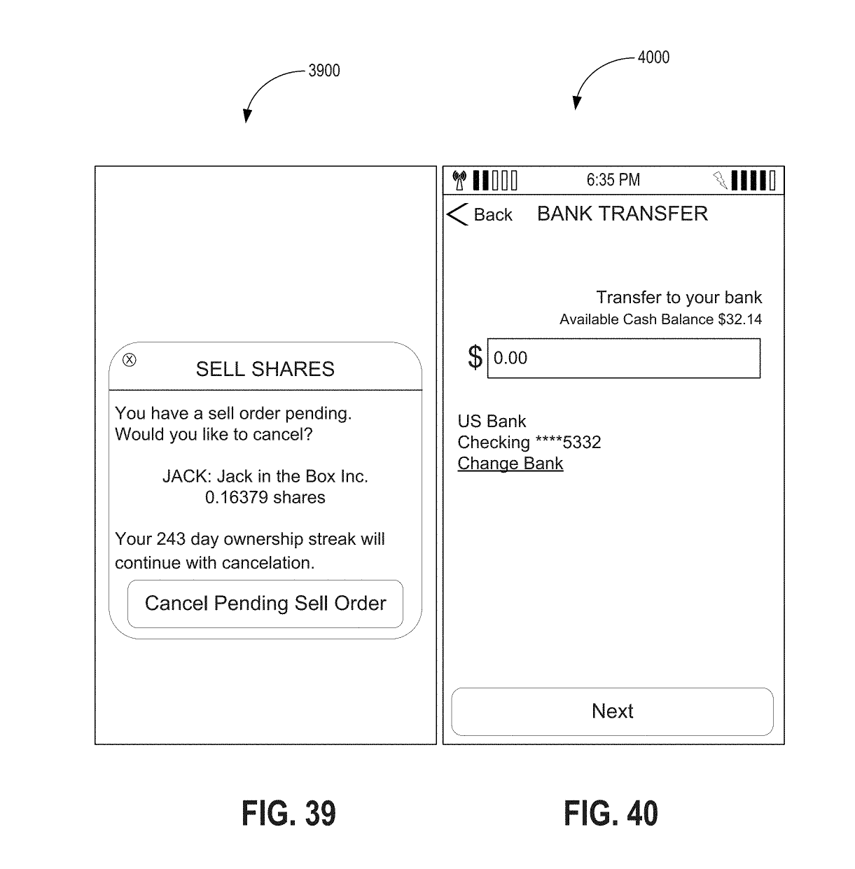

At FIG. 39, the Updated Company GUI 3800 is shown with the third Sell Shares dialog box shown over updated Company GUI 3800. The third Sell Shares dialog box may include a “Cancel Pending Sell Order” selectable UI object which, upon a user's selection, may cancel a pending sell order, in this example, for shares in JACK. The third Sell Shares dialog may also include a loyalty notification which may inform a user that an ownership streak will come to an end if they sell all equity in a position. In an example, the third Sell Shares dialog window may include an “X” selectable UI object, which, upon a user's selection, will close out of the third Sell Shares dialog window and return the user to Updated Company GUI 3800. Once clearing system 104 is able to execute the sell order, the loyalty platform 108 may receive funds from the sale of shares from clearing system 104 and deposit them in user funds 160

At FIG. 40, an example Bank Transfer GUI 4000 is shown. The Bank Transfer GUI may include an available cash balance (available funds in user funds 160), an entry field for a user to enter a transfer amount, a bank snapshot, a switch bank option, and a “Next” selectable UI object. As an example, an available cash balance may be determined from available funds in user funds 160 by accounts 114. In another example, the entry field may be a field where a user may enter the amount of funds the user wishes to transfer from user funds 160 to payments system 150 e.g., a bank, checking account). The bank snapshot, as an example, may provide any applicable identifying information relating to the example user's account at payments system 150. The switch bank option may bring up a dialog for a user to select a different payments system to receive the bank transfer. The “Next” selectable UI object may bring up a confirmation window, upon a user's selection, in order to confirm the bank transfer and transfer the amount of funds entered into the entry field from user funds 160 to the appropriate payments 150.

In one embodiment, a method comprises, receiving a loyalty selection from a user, the loyalty selection comprising a selection of a business listed in a rewarding-business index of a loyalty platform to receive an equity reward associated with the business; matching a user purchase with the business by correlating purchase details with the rewarding-business index; determining an amount of the equity reward based on a monetary value of the user purchase, a user transaction history, and business reward policies; and displaying the amount of the equity reward to the user

In a first example of the method, the loyalty selection excludes the user from receiving equity rewards associated with unselected businesses. In a second example of the method optionally including the first example, displaying the amount of the equity reward to the user includes rendering the amount of the equity reward in a user interface of a user computing device. In a third example of the method, optionally including the first and second examples, the business is a first business and is included in a first market of the loyalty platform and not included in a second market of the loyalty platform, where the loyalty selection to the first business excludes the user from receiving equity rewards from a second business included in the first market of the loyalty platform, and wherein the loyalty selection does not exclude the user from receiving equity rewards from a third business, wherein the third business is included in the second market of the loyalty platform and not included in the first market of the loyalty platform. In a fourth example of the method, optionally including the first through third examples, the business is included in a plurality of markets of the loyalty platform. In a fifth example of the method, optionally including the first through fourth examples, the loyalty selection includes selection of the business in one or more of the additional markets. In a sixth example of the method, optionally including the first through fifth examples, matching the user purchase with the business by correlating purchase details with the rewarding-business index comprises the loyalty platform tracking purchases made with a linked payment medium used to conduct the user purchase. In a seventh example of the method, optionally including the first through sixth examples, the linked payment medium comprises one of a debit card, a credit card, and a virtual wallet. In an eighth example of the method, optionally including the first through seventh examples, the method further comprising prompting the user to make the loyalty selection to the business based on the user being within a threshold distance of the business. In a ninth example of the method, optionally including the first through eighth examples, determining the amount of the equity reward includes increasing the amount of the equity reward as a cumulative monetary value of user purchases from the business increases. In a tenth example of the method, optionally including the first through ninth examples, determining the amount of the equity reward includes applying a reward modifier to the amount of the equity reward to form a modified amount of the equity reward. In an eleventh example of the method, optionally including the first through tenth examples, the amount of the equity reward comprises an amount of fractional shares of stock in the business.

In another embodiment, on a computing system implementing a loyalty platform, a method comprising: receiving a loyalty selection from a user via a user computing device, wherein the user computing device is associated with a user account on the loyalty platform, the loyalty selection comprising a selection of a business listed in a rewarding-business index of the loyalty platform to receive an equity reward associated with the business; obtaining purchase details of a user purchase made at the business with a linked payment medium, wherein the linked payment medium is linked to the user account on the loyalty platform; matching the user purchase with the business by correlating the purchase details with the rewarding-business index; determining an amount of the equity reward based on a monetary value of the user purchase, a user transaction history, and reward policies of the business; and displaying the amount of the equity reward to the user computing device.

In a first example of the method, matching the user purchase with the business by correlating the purchase details with the rewarding-business index comprises matching a transacting business description associated with the user purchase to a description of the business stored in the rewarding-business index. In a second example of the method, optionally including the first example, obtaining purchase details includes accessing a record of purchases made with the linked payment medium.

In another embodiment, a computing system implementing a loyalty platform, comprising: a processor; and a non-transitory memory storing instructions that when executed by the processor perform the steps of: receiving a loyalty selection from a user computing device, the loyalty selection comprising a selection of a business listed in a rewarding-business index of a loyalty platform to receive an equity reward associated with the business; matching a user purchase with the business by correlating a transacting business description associated with the purchase with a description of the business stored in the rewarding-business index of the loyalty platform; determining an amount of the equity reward based on a monetary value of the user purchase, a user transaction history, and business reward policies; and displaying the amount of the equity reward to the user computing device.

In a first example of the system, determining the amount of the equity reward further comprises determining the amount of the equity reward as a percentage of the monetary value of the user purchase. In a second example of the system, optionally including the first example, the percentage is based on a payment medium used to conduct the user purchase and further based on the user transaction history. In a third example of the system, optionally including the first and second example, the instructions further comprise issuing a buy order for the amount of the equity reward via a clearing system. In a fourth example of the system, optionally including the first through third examples, the instructions further comprise issuing a sell order for the amount of the equity reward via the clearing system.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed

The subject matter of the present disclosure includes all novel and non-obvious combinations and sub-combinations of the various processes, systems and configurations, and other features, functions, acts, and/or properties disclosed herein, as well as any and all equivalents thereof.

1. A method, comprising:
receiving a loyalty selection from a user, the loyalty selection comprising a selection of a business listed in a rewarding-business index of a loyalty platform to receive an equity reward associated with the business;
matching a user purchase with the business by correlating purchase details with the rewarding-business index;
determining an amount of the equity reward based on a monetary value of the user purchase, a user transaction history, and business reward policies; and
displaying the amount of the equity reward to the user.

2. The method of claim 1, wherein the loyalty selection excludes the user from receiving equity rewards associated with unselected businesses.

3. The method of claim 1, wherein displaying the amount of the equity reward to the user includes rendering the amount of the equity reward in a user interface of a user computing device.

4. The method of claim 1, wherein the business is a first business and is included in a first market of the loyalty platform and not included in a second market of the loyalty platform, where the loyalty selection to the first business excludes the user from receiving equity rewards from a second business included in the first market of the loyalty platform, and wherein the loyalty selection does not exclude the user from receiving equity rewards from a third business, wherein the third business is included in the second market of the loyalty platform and not included in the first market of the loyalty platform.

5. The method of claim 1, wherein the business is included in a plurality of markets of the loyalty platform.

6. The method of claim 5, wherein the loyalty selection includes selection of the business in one or more of the plurality of markets of the loyalty platform.

7. The method of claim 1, wherein matching the user purchase with the business by correlating purchase details with the rewarding-business index comprises the loyalty platform tracking purchases made with a linked payment medium used to conduct the user purchase.

8. The method of claim 7, wherein the linked payment medium comprises one of a debit card, a credit card, and a virtual wallet.

9. The method of claim 1, further comprising, prompting the user to make the loyalty selection to the business based on the user being within a threshold distance of the business.

10. The method of claim 1, wherein determining the amount of the equity reward includes increasing the amount of the equity reward as a cumulative monetary value of user purchases from the business increases.

11. The method of claim 1, wherein determining the amount of the equity reward includes applying a reward modifier to the amount of the equity reward to form a modified amount of the equity reward.

12. The method of claim 1, wherein the amount of the equity reward comprises an amount of fractional shares of stock in the business.

13. On a computing system implementing a loyalty platform, a method comprising:
receiving a loyalty selection from a user via a user computing device, wherein the user computing device is associated with a user account on the loyalty platform, the loyalty selection comprising a selection of a business listed in a rewarding-business index of the loyalty platform to receive an equity reward associated with the business;
obtaining purchase details of a user purchase made at the business with a linked payment medium, wherein the linked payment medium is linked to the user account on the loyalty platform;
matching the user purchase with the business by correlating the purchase details with the rewarding-business index;
determining an amount of the equity reward based on a monetary value of the user purchase, a user transaction history, and reward policies of the business; and
displaying the amount of the equity reward to the user computing device.

14. The method of claim 13, wherein matching the user purchase with the business by correlating the purchase details with the rewarding-business index comprises matching a transacting business description associated with the user purchase to a description of the business stored in the rewarding-business index.

15. The method of claim 13, wherein obtaining purchase details includes accessing a record of purchases made with the linked payment medium.

16. A computing system implementing a loyalty platform, comprising:
a processor; and
a non-transitory memory storing instructions that when executed by the processor perform the steps of:
receiving a loyalty selection from a user computing device, the loyalty selection comprising a selection of a business listed in a rewarding-business index of a loyalty platform to receive an equity reward associated with the business;
matching a user purchase with the business by correlating a transacting business description associated with the purchase with a description of the business stored in the rewarding-business index of the loyalty platform;
determining an amount of the equity reward based on a monetary value of the user purchase, a user transaction history, and business reward policies; and
displaying the amount of the equity reward to the user computing device.

17. The system of claim 16, wherein determining the amount of the equity reward further comprises determining the amount of the equity reward as a percentage of the monetary value of the user purchase.

18. The system of claim 17, wherein the percentage is based on a payment medium used to conduct the user purchase and further based on the user transaction history.

19. The system of claim 16, wherein the instructions further comprise issuing a buy order for the amount of the equity reward via a clearing system.

20. The system of claim 19, wherein the instructions further comprise issuing a sell order for the amount of the equity reward via the clearing system.
